(19) United States
(12) Patent Application Publication
(10) Pub. No.: US 2026/0177727 A1
(43) Pub. Date: Jun. 25, 2026

(54) OPTICAL PATH FOLDING CAMERA MODULE AND ELECTRONIC DEVICE

(71) Applicant: LARGAN PRECISION CO., LTD., Taichung City (TW)

(72) Inventors: Chien-Hsun WU, Taichung City (TW); Shen-Wu HSIAO, Taichung City (TW); I Yung KUO, Taichung City (TW)

(73) Assignee: LARGAN PRECISION CO., LTD., Taichung City (TW)

(21) Appl. No.: 19/194,771

(22) Filed: Apr. 30, 2025

(30) Foreign Application Priority Data
Dec. 24, 2024 (TW) 113150416

(51) Int. Cl. G02B 5/00

(52) U.S. Cl. CPC G02B 5/005

(57) ABSTRACT

An optical path folding camera module includes a light folding element, an object-side lens element, an image-side lens element, and a light-blocking sheet. The light folding element has a reflection surface. The object-side lens element has an optical surface being spherical or aspheric and being disposed corresponding to the reflection surface. The light-blocking sheet is disposed between the optical surface and the reflection surface. The light-blocking sheet includes an object-side surface, an image-side surface, a light-blocking part, and a light opening. The image-side surface is disposed opposite to the object-side surface and facing towards the reflection surface. The light-blocking part is connected to the object-side surface and the image-side surface and has a light-blocking surface. The light opening is defined by the light-blocking surface. The light-blocking surface continuously extends towards the object-side surface and the image-side surface without any crack.

### RELATED APPLICATIONS

This application claims priority to Taiwan Application 113150416 filed on Dec. 24, 2024, which is incorporated by reference herein in its entirety.

### BACKGROUND

### Technical Field

The present disclosure relates to an optical path folding camera module and an electronic device, more particularly to an optical path folding camera module applicable to an electronic device.

### Description of Related Art

With the development of technology, featuring high image quality becomes one of the indispensable features of an optical system nowadays. Furthermore, electronic devices equipped with optical systems are trending towards multi-functionality for various applications, and therefore the functionality requirements for the optical systems have been increasing.

However, conventional optical systems are difficult to meet the requirement of high optical quality of an electronic device under diversified development in recent years, especially image quality which would be easily affected due to non-imaging light (e.g., stray light) in a lens. The conventional configuration inside a lens is prone to generate non-imaging stray light due to reflection, and therefore it is difficult to meet progressive market requirements in optical quality nowadays. Therefore, how to improve the configuration inside a lens to prevent generating non-imaging stray light for meeting the requirement of high-end-specification electronic devices is an important topic in this field nowadays.

### SUMMARY

According to one aspect of the present disclosure, an optical path folding camera module has, in order from an object side to an image side, a first optical axis and a second optical axis. The optical path folding camera module includes a light folding element, an object-side lens element through which the first optical axis is disposed, an image-side lens element through which the second optical axis is disposed, and a light-blocking sheet. The light folding element has a reflection surface configured to deflect the first optical axis to the second optical axis. The object-side lens element has at least one optical surface being spherical or aspheric and being disposed corresponding to the reflection surface along the first optical axis. The light-blocking sheet is disposed between a surface of the at least one optical surface and the reflection surface. The light-blocking sheet includes an object-side surface, an image-side surface, a light-blocking part, and a light opening. The object-side surface faces towards the object side. The image-side surface is disposed opposite to the object-side surface and faces towards the reflection surface. The light-blocking part is connected to the object-side surface and the image-side surface. The light-blocking part is disposed facing towards the first optical axis. The light-blocking part is located closer to the first optical axis than the image-side lens element. The light-blocking part has a light-blocking surface surrounding the first optical axis. The light opening is defined by the light-blocking surface of the light-blocking part. The light-blocking surface of the light-blocking part continuously extends towards the object-side surface and the image-side surface without any crack.

According to another aspect of the present disclosure, an optical path folding camera module has, in order from an object side to an image side, a first optical axis and a second optical axis. The optical path folding camera module includes a light folding element, an image-side lens element through which the second optical axis is disposed, and a light-blocking layer. The light folding element has a reflection surface and at least one optical surface through which the first optical axis is disposed. The reflection surface is configured to deflect the first optical axis to the second optical axis. The at least one optical surface is spherical or aspheric. The light-blocking layer is disposed on an object side of the reflection surface. The light-blocking layer includes an object-side surface, an image-side surface, a light-blocking part, a light opening. The object-side surface faces towards the object side. The image-side surface is disposed opposite to the object-side surface and faces towards the reflection surface. The light-blocking part is connected to the object-side surface and the image-side surface. The light-blocking part is disposed facing towards the first optical axis. The light-blocking part is located closer to the first optical axis than the image-side lens element. The light-blocking part has a light-blocking surface surrounding the first optical axis. The light opening is defined by the light-blocking surface of the light-blocking part. The light-blocking layer is attached on the at least one optical surface. The light-blocking layer extends along a direction parallel to the first optical axis and extends towards the first optical axis. When a height of the light-blocking layer in a direction parallel to the first optical axis is h1, a height difference of a surface of the at least one optical surface where the light-blocking layer is attached in a direction parallel to the first optical axis is h2, a distance along the first optical axis between the reflection surface and a surface of the light-blocking layer closest to the reflection surface is Db, and a distance along the first optical axis between the reflection surface and a surface of the at least one optical surface closest to the reflection surface is Do, the following conditions are satisfied: 0<h1/h2<1.2; and 0.3<Db/Do<2.

According to another aspect of the present disclosure, an optical path folding camera module has, in order from an object side to an image side, a first optical axis and a second optical axis. The optical path folding camera module includes a light folding element, an object-side lens element through which the first optical axis is disposed, an image-side lens element through which the second optical axis is disposed, and a light-blocking layer. The light folding element has a reflection surface configured to deflect the first optical axis to the second optical axis. The object-side lens element has at least one optical surface being spherical or aspheric. The light-blocking layer is disposed on the light folding element. The light-blocking layer includes an object-side surface, an image-side surface, a light-blocking part, and a light opening. The object-side surface faces towards the object side. The image-side surface is disposed opposite to the object-side surface and faces towards the reflection surface. The light-blocking part is connected to the object-side surface and the image-side surface. The light-blocking part is disposed facing towards the first optical axis. The light-blocking part is located closer to the first optical axis than the image-side lens element. The light-blocking part has a light-blocking surface surrounding the first optical axis. The light opening is defined by the light-blocking surface of the light-blocking part. The light-blocking part further has a plurality of curved structures in a direction perpendicular to the first optical axis. The plurality of curved structures extend towards the first optical axis from the light-blocking surface. The plurality of curved structures are arranged along a whole contour of at least one side of the light-blocking part.

According to another aspect of the present disclosure, an optical path folding camera module has, in order from an object side to an image side, a first optical axis and a second optical axis. The optical path folding camera module includes a light folding element, an object-side lens element through which the first optical axis is disposed, an image-side lens element through which the second optical axis is disposed, and a light-blocking sheet. The light folding element has a reflection surface configured to deflect the first optical axis to the second optical axis. The object-side lens element has at least one optical surface being spherical or aspheric and being disposed corresponding to the reflection surface along the first optical axis. The light-blocking sheet is disposed between a surface of the at least one optical surface and the reflection surface. The light-blocking sheet includes an object-side surface, an image-side surface, a light-blocking part, and a light opening. The object-side surface faces towards the object side. The image-side surface is disposed opposite to the object-side surface and faces towards the reflection surface. The light-blocking part is connected to the object-side surface and the image-side surface. The light-blocking part is disposed facing towards the first optical axis. The light-blocking part is located closer to the first optical axis than the image-side lens element. The light-blocking part has a light-blocking surface surrounding the first optical axis. The light opening is defined by the light-blocking surface of the light-blocking part. The light-blocking part further has a plurality of curved structures in a direction perpendicular to the first optical axis. The plurality of curved structures extend towards the first optical axis from the light-blocking surface. The plurality of curved structures are arranged along at least one contour of the light-blocking part.

The light-blocking surface of the light-blocking part is arranged, from the object-side surface to the image-side surface, gradually close to the first optical axis or gradually away from the first optical axis.

According to another aspect of the present disclosure, an electronic device includes one of the aforementioned optical path folding camera modules.

### BRIEF DESCRIPTION OF THE DRAWINGS

The disclosure can be better understood by reading the following detailed description of the embodiments, with reference made to the accompanying drawings as follows:

FIG. 1 is a perspective view of an optical path folding camera module according to the 1st embodiment of the present disclosure;

FIG. 2 is a top view of the optical path folding camera module in FIG. 1;

FIG. 3 is a cross-sectional view of the optical path folding camera module along A-A line in FIG. 2;

FIG. 4 is an enlarged view of BB region in FIG. 3;

FIG. 5 is a top view of a light-blocking sheet of an optical path folding camera module according to the 2nd embodiment of the present disclosure;

FIG. 6 is a cross-sectional view of the light-blocking sheet along C-C line in FIG. 5, with an enlarged view of DD region thereof;

FIG. 7 is a top view of a light-blocking sheet of an optical path folding camera module according to the 3rd embodiment of the present disclosure;

FIG. 8 is a cross-sectional view of the light-blocking sheet along E-E line in

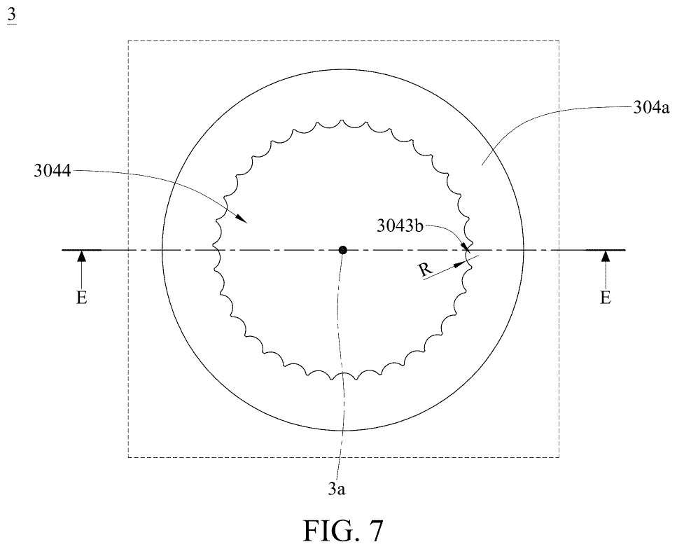

FIG. 7, with an enlarged view of FF region thereof;

FIG. 9 is a top view of a light-blocking sheet of an optical path folding camera module according to the 4th embodiment of the present disclosure;

FIG. 10 is a cross-sectional view of the light-blocking sheet along G-G line in FIG. 9, with an enlarged view of HH region thereof;

FIG. 11 is a perspective view of an optical path folding camera module according to the 5th embodiment of the present disclosure;

FIG. 12 is a top view of the optical path folding camera module in FIG. 11;

FIG. 13 is a cross-sectional view of the optical path folding camera module along I-I line in FIG. 12;

FIG. 14 is an enlarged view of JJ region in FIG. 13;

FIG. 15 is a perspective view of a light folding element and a light-blocking layer of an optical path folding camera module according to the 6th embodiment of the present disclosure;

FIG. 16 is a top view of the light-blocking layer in FIG. 15;

FIG. 17 is a cross-sectional view of the light-blocking layer along K-K line in

FIG. 16, with an enlarged view of LL region thereof;

FIG. 18 is a perspective view of a light folding element and a light-blocking layer of an optical path folding camera module according to the 7th embodiment of the present disclosure;

FIG. 19 is a top view of the light-blocking layer in FIG. 18;

FIG. 20 is a cross-sectional view of the light-blocking layer along M-M line in FIG. 19, with an enlarged view of NN region thereof;

FIG. 21 is a perspective view of a light folding element and a light-blocking layer of an optical path folding camera module according to the 8th embodiment of the present disclosure;

FIG. 22 is a top view of the light-blocking layer in FIG. 21;

FIG. 23 is a cross-sectional view of the light-blocking layer along O—O line in

FIG. 22, with an enlarged view of PP region thereof;

FIG. 24 is a top view of a light folding element and a light-blocking layer of an optical path folding camera module according to the 9th embodiment of the present disclosure;

FIG. 25 is a top view of a light folding element and a light-blocking layer of an optical path folding camera module according to the 10th embodiment of the present disclosure;

FIG. 26 is a cross-sectional view of an optical path folding camera module according to the 11th embodiment of the present disclosure;

FIG. 27 is a partial view of the optical path folding camera module in FIG. 26, with an enlarged view of QQ region thereof;

FIG. 28 is a cross-sectional view of an optical path folding camera module according to the 12th embodiment of the present disclosure;

FIG. 29 is a partial view of the optical path folding camera module in FIG. 28, with an enlarged view of RR region thereof;

FIG. 30 is a perspective view of an optical path folding camera module according to the 13th embodiment of the present disclosure;

FIG. 31 is a top view of the optical path folding camera module in FIG. 30;

FIG. 32 is a cross-sectional view of the optical path folding camera module along S-S line in FIG. 31;

FIG. 33 is an enlarged view of TT region in FIG. 32;

FIG. 34 is a top view of a light-blocking sheet of an optical path folding camera module according to the 14th embodiment of the present disclosure;

FIG. 35 is a perspective view of a light folding element and a light-blocking layer of an optical path folding camera module according to the 15th embodiment of the present disclosure;

FIG. 36 is a cross-sectional view of the light folding element and the light-blocking layer in FIG. 35;

FIG. 37 is a cross-sectional view of the light folding element and the light-blocking layer alone U-U line in FIG. 36;

FIG. 38 is a top view of the light-blocking layer in FIG. 37;

FIG. 39 is a cross-sectional view of the light-blocking layer along V-V line in

FIG. 38, with an enlarged view of WW region thereof;

FIG. 40 is a perspective view of an optical path folding camera module according to the 16th embodiment of the present disclosure;

FIG. 41 is a top view of the optical path folding camera module in FIG. 40;

FIG. 42 is a cross-sectional view of the optical path folding camera module along X-X line in FIG. 41;

FIG. 43 is a perspective view of the light folding element and the light-blocking layer of the optical path folding camera module in FIG. 42;

FIG. 44 is a top view of the light-blocking layer in FIG. 43;

FIG. 45 is a cross-sectional view of the light folding element and the light-blocking layer in FIG. 43, with an enlarged view of YY region thereof;

FIG. 46 is one perspective view of an electronic device according to the 17th embodiment of the present disclosure;

FIG. 47 is another perspective view of the electronic device in FIG. 46;

FIG. 48 is an image captured by an ultra-wide-angle camera module;

FIG. 49 is an image captured by a high pixel camera module;

FIG. 50 is an image captured by a telephoto camera module;

FIG. 51 is one perspective view of an electronic device according to the 18th embodiment of the present disclosure;

FIG. 52 is a perspective view of an electronic device according to the 19th embodiment of the present disclosure;

FIG. 53 is a side view of the electronic device in FIG. 52; and

FIG. 54 is a top view of the electronic device in FIG. 52.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides an optical path folding camera module which has, in order from an object side to an image side, a first optical axis and a second optical axis.

The optical path folding camera module can include a light folding element, an object-side lens element and an image-side lens element. The light folding element can be a prism or a reflective mirror, but the present disclosure is not limited thereto. The object-side lens element or the image-side lens element can be a single lens element, can be a single lens group composed by a plurality of lens elements, or can be a plurality of lens groups, and the present disclosure is not limited thereto. Please be noted that the imaging abilities of the object-side lens element and the image-side lens element are not intended to restrict the present disclosure, and therefore part of the contours of the object-side lens element and the image-side lens element is omitted to prevent obscure the present disclosure.

The light folding element has a reflection surface configured to deflect the first optical axis to the second optical axis. The first optical axis can be disposed through the object-side lens element, and the second optical axis can be disposed through the image-side lens element. Therefore, it is favorable for meet the miniaturization requirement of the optical path folding camera module.

At least one of the object-side lens element and the light folding element can have at least one optical surface being spherical or aspheric. The at least one optical surface can be manufactured by glass molding or plastic injection molding, but the present disclosure is not limited thereto. Moreover, the at least one optical surface can be disposed corresponding to the reflection surface along the first optical axis. Moreover, the first optical axis can be disposed through the at least one optical surface.

The optical path folding camera module can further include a light-blocking sheet or a light-blocking layer. The light-blocking sheet or the light-blocking layer can be disposed on an object side of the reflection surface. Moreover, the light-blocking sheet or the light-blocking layer can be disposed between the reflection surface and a surface of the at least one optical surface.

In the case that the optical path folding camera module further includes the light-blocking sheet, the light-blocking sheet can be spaced apart from an adjacent optical element by an air gap therebetween, but the present disclosure is not limited thereto. Please be noted that said adjacent optical element can be, for example, the object-side lens element, the image-side lens element, the light folding element as mentioned above, or other imaging-related element.

In the case that the optical path folding camera module further includes the light-blocking layer, the light-blocking layer can be attached on the at least one optical surface, and the light-blocking layer can extend along a direction parallel to the first optical axis and extend towards the first optical axis. Therefore, it is favorable for providing wide applicability of the light-blocking layer. Moreover, the light-blocking layer can be disposed on the light folding element. Please be noted that the light-blocking layer can be manufactured by photoresist curing, in which positive photoresist and negative photoresist may be included, but the present disclosure is not limited thereto.

The light-blocking sheet or the light-blocking layer can include an object-side surface, an image-side surface, a light-blocking part and a light opening. The object-side surface faces towards the object side. The image-side surface is disposed opposite to the object-side surface and faces towards the reflection surface. The light-blocking part is connected to the object-side surface and the image-side surface. Moreover, the light-blocking part is disposed facing towards the first optical axis. Moreover, the light-blocking part is located closer to the first optical axis than the image-side lens element.

The light-blocking part has a light-blocking surface surrounding the first optical axis. The light opening is defined by the light-blocking surface of the light-blocking part. Moreover, the light-blocking surface can define the shape, the size and the configuration of the light opening, but the present disclosure is not limited thereto.

According to the optical path folding camera module of the present disclosure discussed above, by arranging the at least one optical surface on an object side of the reflection surface of the light folding element, with collaboration with the light-blocking sheet or the light-blocking layer disposed on the object side of the reflection surface of the light folding element, it is favorable for providing an optical configuration with an anti-stray light countermeasure so as to provide high image quality, while satisfying the miniaturization requirement and the industrial applicability of the camera module.

The light-blocking surface of the light-blocking part can be arranged, from the object-side surface to the image-side surface, gradually close to the first optical axis or gradually away from the first optical axis. Therefore, it is favorable for improving the product yield rate. Moreover, the light-blocking surface of the light-blocking part can continuously extend towards the object-side surface and the image-side surface without any crack. Therefore, it is favorable for reducing loss of optical imaging signal so as to improve signal-to-noise ratio of the image.

The light-blocking part can further have a plurality of curved structures in a direction perpendicular to the first optical axis. The plurality of curved structures can extend towards the first optical axis from the light-blocking surface. The plurality of curved structures can be integrally formed with the light-blocking part, but the present disclosure is not limited thereto. The plurality of curved structures can be arranged along at least one contour of the light-blocking part. Therefore, it is favorable for further reducing the possibility of generation of stray light. Moreover, the plurality of curved structures can also be arranged along a straight line in a direction parallel to the second optical axis. Therefore, it is favorable for further ensuring imaging quality and increasing design flexibility of the curved structures. Moreover, the plurality of curved structures can also be arranged along the whole contour of at least one side of the light-blocking part.

The light-blocking sheet or the light-blocking layer can further include a plurality of specifically-shaped additives that can be uniformly distributed within the light-blocking sheet or the light-blocking layer. Therefore, it is favorable for increasing the mechanical strengthen of the light-blocking sheet or the light-blocking layer.

According to the present disclosure, the optical path folding camera module can further include a driving device that can provide the light folding element with a rotation axis and a degree of freedom rotating about the rotation axis. Therefore, it is favorable for maintaining the focus ability of the camera module.

In the case that the optical path folding camera module further includes the light-blocking layer, a height of the light-blocking layer in a direction parallel to the first optical axis is h1, a height difference of a surface of the at least one optical surface where the light-blocking layer is attached in a direction parallel to the first optical axis is h2, and the following condition can be satisfied: 0<h1/h2<1.2. Therefore, it is favorable for further increasing image quality.

When a distance along the first optical axis between the reflection surface and a surface of the light-blocking sheet or the light-blocking layer closest to the reflection surface is Db, and a distance along the first optical axis between the reflection surface and a surface of the at least one optical surface closest to the reflection surface is Do, the following condition can be satisfied: 0.3<Db/Do<2. Therefore, it is favorable for further ensuring the light-blocking efficiency and providing design flexibility in arrangement position of the light-blocking sheet or the light-blocking layer. Moreover, the following condition can also be satisfied: 0.5<Db/Do<1.3. Therefore, it is favorable for ensuring the feasibility of the product assembly.

When a curvature radius of the plurality of curved structures at a side thereof close to the object-side surface in a direction perpendicular to the first optical axis is R, the following condition can be satisfied: 0.05 mm (millimeters)≤R<1.7 mm. Therefore, it is favorable for further ensuring image quality and increasing design flexibility of the curved structures. Moreover, the following condition can also be satisfied: 0.08 mm≤R<1.5 mm. Therefore, it is favorable for reducing the manufacturing process difficulty.

The present disclosure provides an electronic device which includes the abovementioned optical path folding camera module.

According to the present disclosure, the aforementioned features and conditions can be utilized in numerous combinations so as to achieve corresponding effect.

According to the above description of the present disclosure, the following specific embodiments are provided for further explanation.

### 1st Embodiment

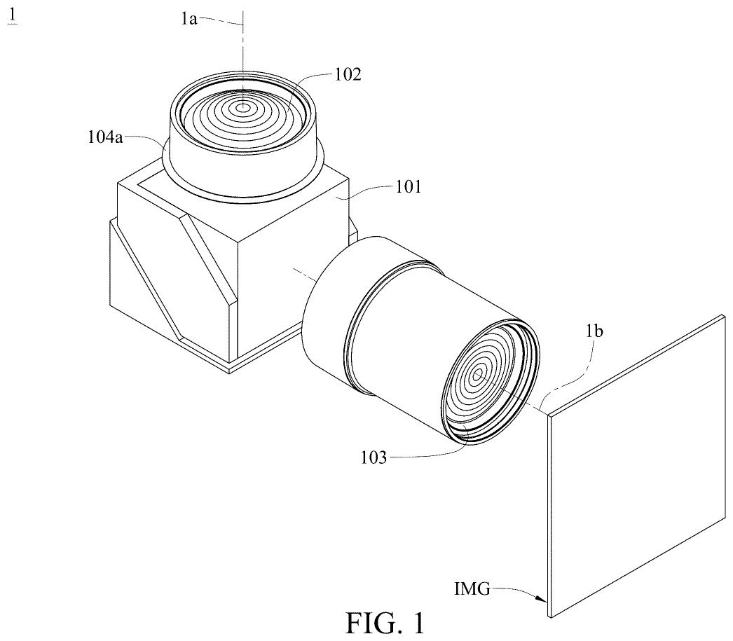

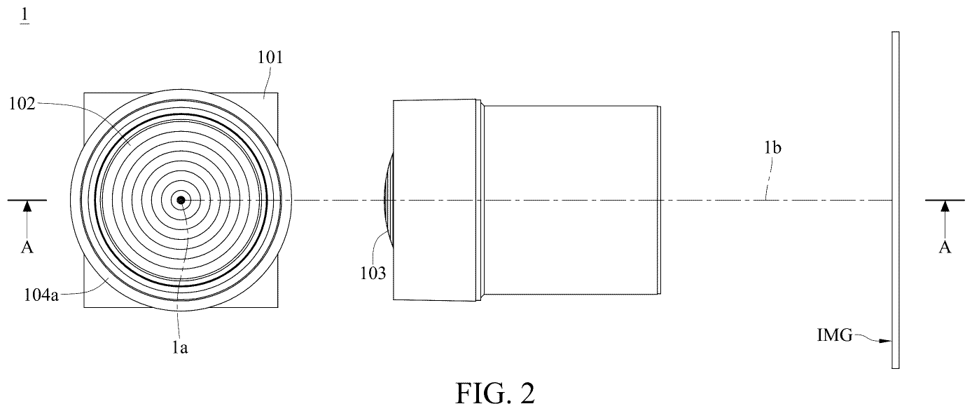

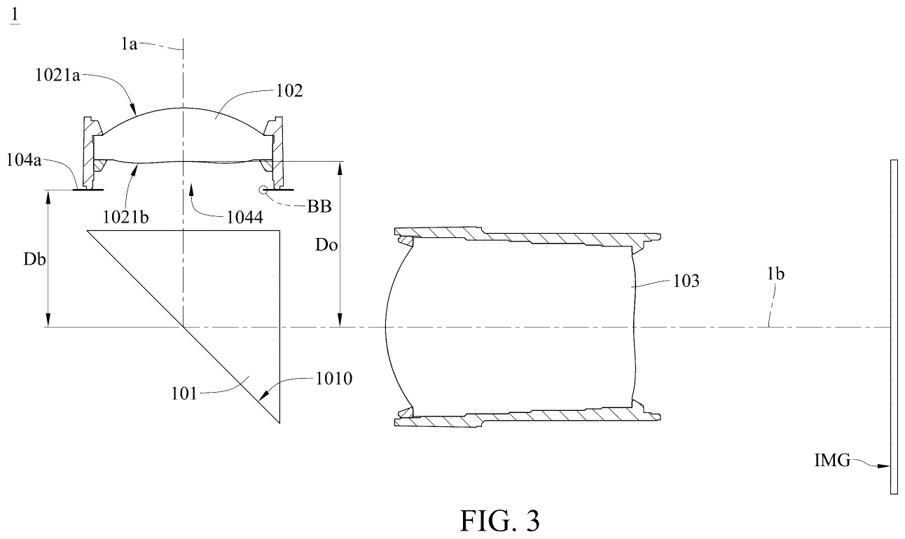

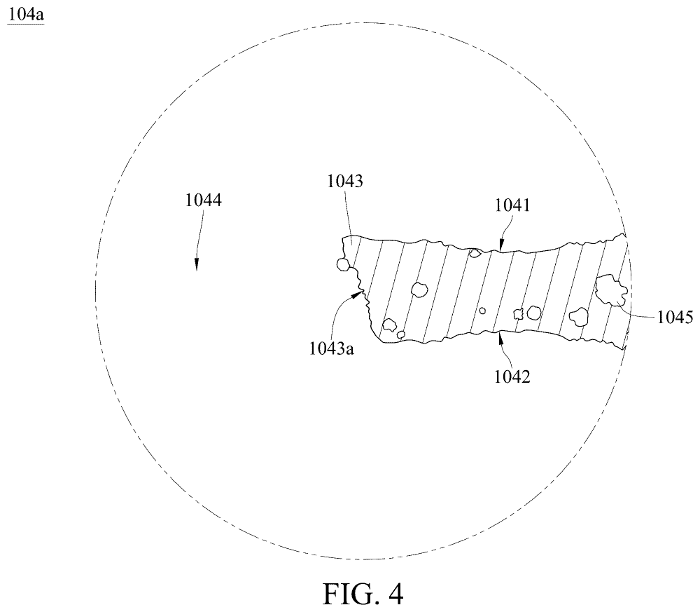

Please refer to FIG. 1 to FIG. 4, where FIG. 1 is a perspective view of an optical path folding camera module according to the 1st embodiment of the present disclosure, FIG. 2 is a top view of the optical path folding camera module in FIG. 1, FIG. 3 is a cross-sectional view of the optical path folding camera module along A-A line in FIG. 2, and FIG. 4 is an enlarged view of BB region in FIG. 3.

An optical path folding camera module 1 provided in this embodiment has, in order from an object side to an image side, a first optical axis 1a and a second optical axis 1b.

The optical path folding camera module 1 includes a light folding element 101, an object-side lens element 102 and an image-side lens element 103. The light folding element 101 is a prism, but the present disclosure is not limited thereto. The object-side lens element 102 is a single lens element, the image-side lens element 103 is a single lens group, but the present disclosure is not limited thereto. Please be noted that part of the contours of the object-side lens element 102 and the image-side lens element 103 is omitted.

The light folding element 101 has a reflection surface 1010. The reflection surface 1010 deflects the first optical axis 1a to the second optical axis 1b. The first optical axis 1a is disposed through the object-side lens element 102, and the second optical axis 1b is disposed through the image-side lens element 103 and extends to an image surface IMG.

The object-side lens element 102 has a plurality of optical surfaces 1021a and 1021b. The optical surfaces 1021a and 1021b are disposed corresponding to the reflection surface 1010 along the first optical axis 1a, and the first optical axis 1a is disposed through the optical surfaces 1021a and 1021b. It can also be considered that the optical surface 1021a faces away from the reflection surface 1010 along the first optical axis 1a, and the optical surface 1021b faces towards the reflection surface 1010 along the first optical axis 1a.

The optical path folding camera module 1 further includes a light-blocking sheet 104a. The light-blocking sheet 104a is disposed on an object side of the reflection surface 1010 and is disposed between the optical surfaces 1021a and 1021b and the reflection surface 1010. The light-blocking sheet 104a is spaced apart from the adjacent light folding element 101 and the object-side lens element 102 by a respective air gap.

The light-blocking sheet 104a includes an object-side surface 1041, an image-side surface 1042, a light-blocking part 1043 and a light opening 1044. The object-side surface 1041 faces towards the object side. The image-side surface 1042 is disposed opposite to the object-side surface 1041 and faces towards the reflection surface 1010. The light-blocking part 1043 is connected to the object-side surface 1041 and the image-side surface 1042. The light-blocking part 1043 is disposed facing towards the first optical axis 1a. The light-blocking part 1043 is located closer to the first optical axis 1a than the image-side lens element 103.

The light-blocking part 1043 has a light-blocking surface 1043a surrounding the first optical axis 1a. The light opening 1044 is defined by the light-blocking surface 1043a of the light-blocking part 1043.

The light-blocking surface 1043a of the light-blocking part 1043 continuously extends towards the object-side surface 1041 and the image-side surface 1042 without any crack. It can also be considered that the light-blocking surface 1043a extends from the object-side surface 1041 to the image-side surface 1042 in a continuous and no-crack manner. The light-blocking surface 1043a is arranged gradually away from the first optical axis 1a along a direction parallel to the first optical axis 1a and from the object side to the image side.

The light-blocking sheet 104a further includes a plurality of specifically-shaped additives 1045. The specifically-shaped additives 1045 are uniformly distributed within the light-blocking sheet 104a.

When a distance along the first optical axis 1a between the reflection surface 1010 and the image-side surface 1042 of the light-blocking sheet 104a closest to the reflection surface 1010 is Db, and a distance along the first optical axis 1a between the reflection surface 1010 and the optical surface 1021b of the optical surfaces 1021a and 1021b closest to the reflection surface 1010 is Do, the following conditions are satisfied: Db=4.09 mm; Do=4.96 mm; and Db/Do=0.82. Please be noted that both Db and Do are measured based on the positions where the reflection surface 1010 and the optical surface 1021b intersect the first optical axis 1a

The light-blocking sheet 104a of this embodiment can be replaced with different forms of light-blocking sheets, provided that the imaging remains unaffected. Please continue to refer to the 2nd embodiment.

### 2nd Embodiment

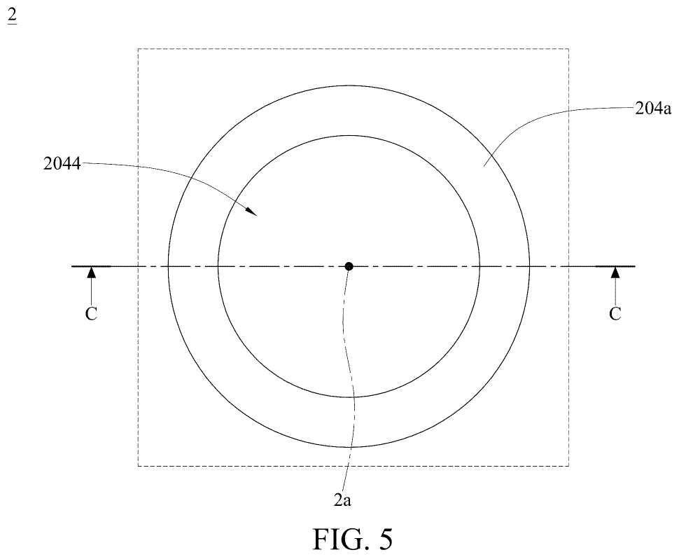

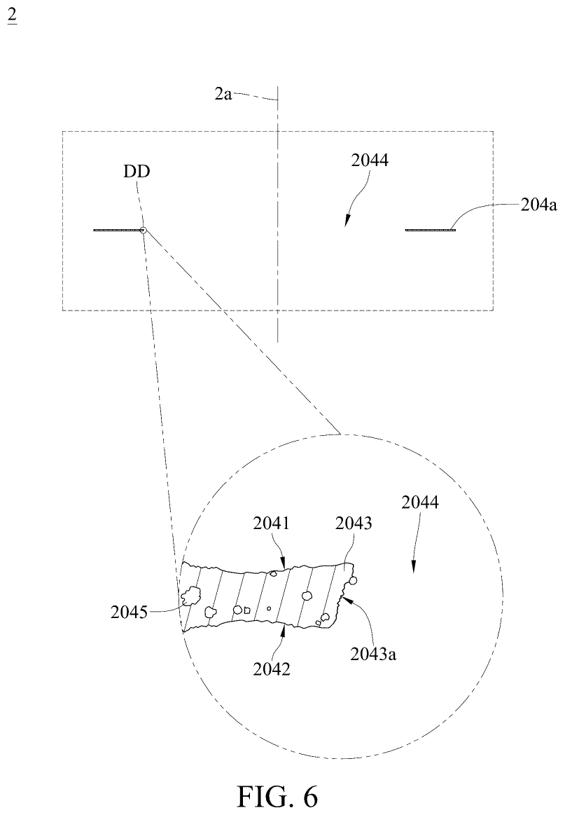

Please refer to FIG. 5 to FIG. 6, where FIG. 5 is a top view of a light-blocking sheet of an optical path folding camera module according to the 2nd embodiment of the present disclosure, and FIG. 6 is a cross-sectional view of the light-blocking sheet along C-C line in FIG. 5, with an enlarged view of DD region thereof.

In the following, a light-blocking sheet 204a, which is provided in this embodiment and can be used to replace the light-blocking sheet 104a in the 1st embodiment, would be illustrated. Please be noted that an optical path folding camera module 2 provided in this embodiment is similar to the optical path folding camera module 1 of the 1st embodiment, and therefore only differences between them, as well as necessary description, would be stated below.

The light-blocking sheet 204a includes an object-side surface 2041, an image-side surface 2042, a light-blocking part 2043 and a light opening 2044. The object-side surface 2041 faces towards the object side. The image-side surface 2042 is disposed opposite to the object-side surface 2041. The light-blocking part 2043 is connected to the object-side surface 2041 and the image-side surface 2042.

The light-blocking part 2043 has a light-blocking surface 2043a surrounding the first optical axis 2a. The light opening 2044 is defined by the light-blocking surface 2043a.

The light-blocking surface 2043a continuously extends towards the object-side surface 2041 and the image-side surface 2042 without any crack. It can also be considered that the light-blocking surface 2043a extends from the object-side surface 2041 to the image-side surface 2042 in a continuous and no-crack manner. The light-blocking surface 2043a is arranged gradually away from the first optical axis 2a along a direction parallel to the first optical axis 2a and from the object side to the image side.

The light-blocking sheet 204a further includes a plurality of specifically-shaped additives 2045. The specifically-shaped additives 2045 are uniformly distributed within the light-blocking sheet 204a.

As shown in FIG. 5, when viewing the light-blocking sheet 204a from the top side thereof, the light-blocking sheet 204a is in a donut-like shape having two concentric circles. However, the present disclosure is not limited thereto. Please continue to refer to the 3rd embodiment.

### 3rd Embodiment

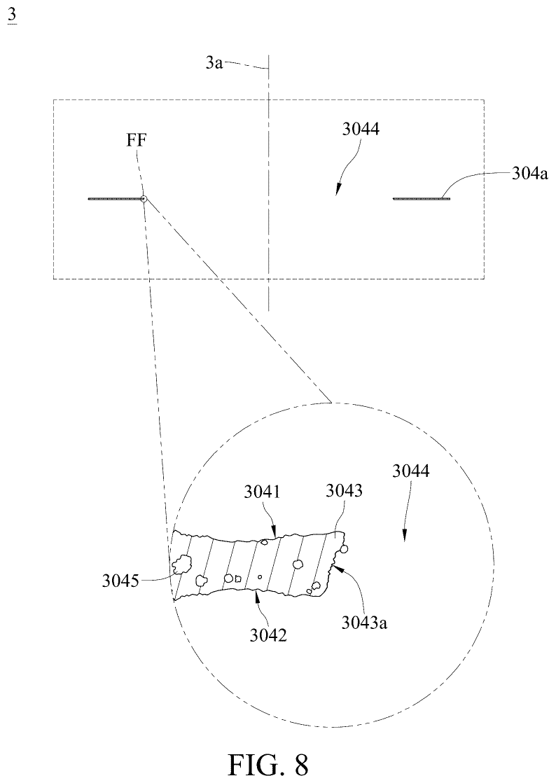

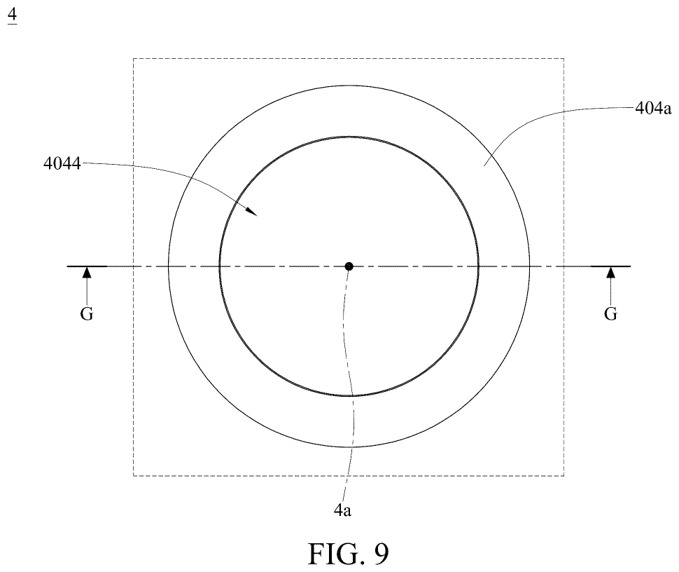

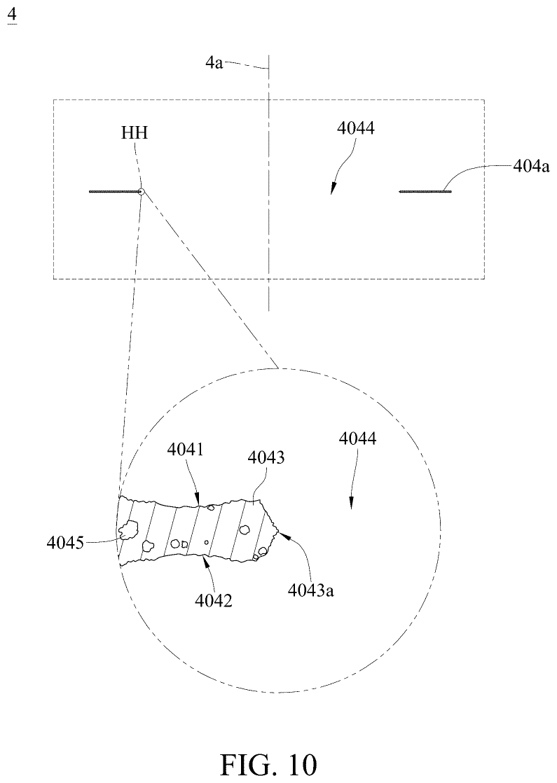

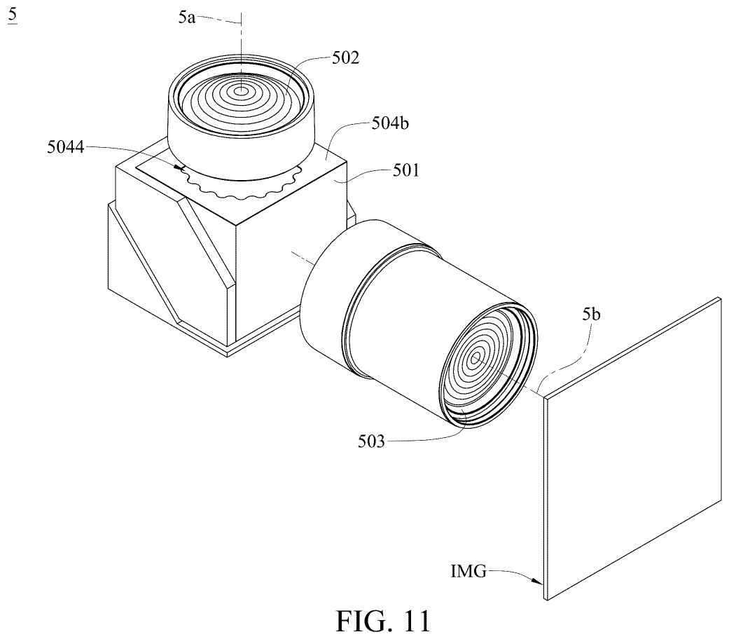

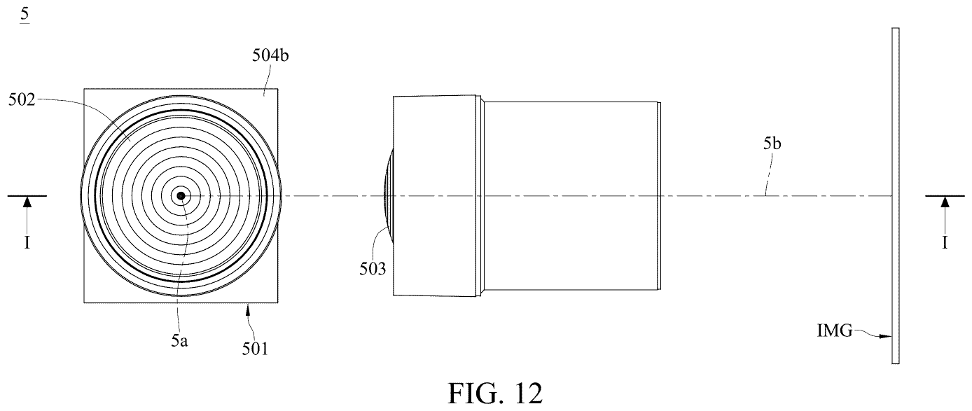

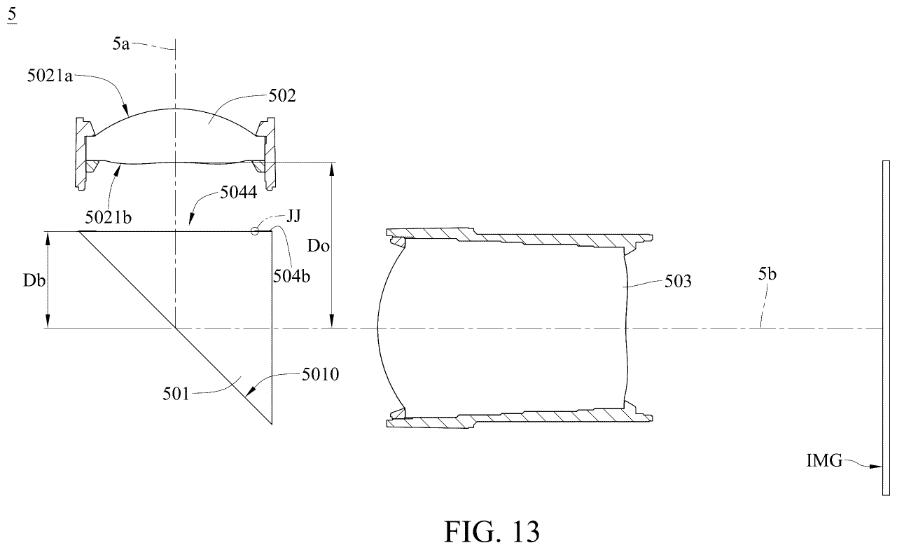

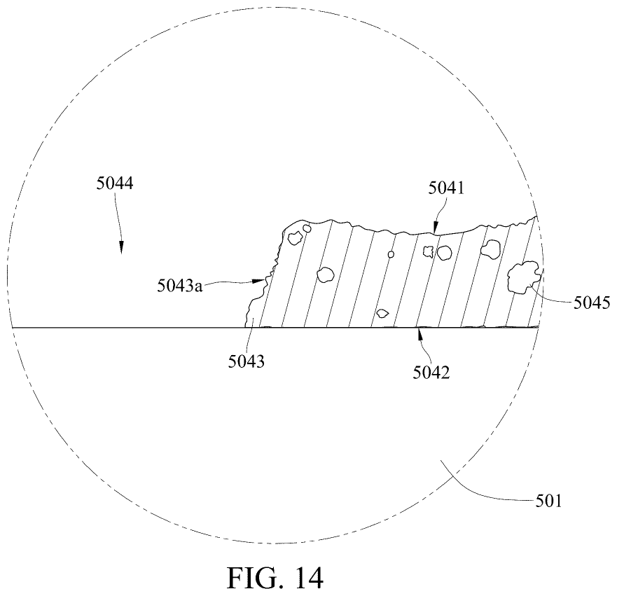

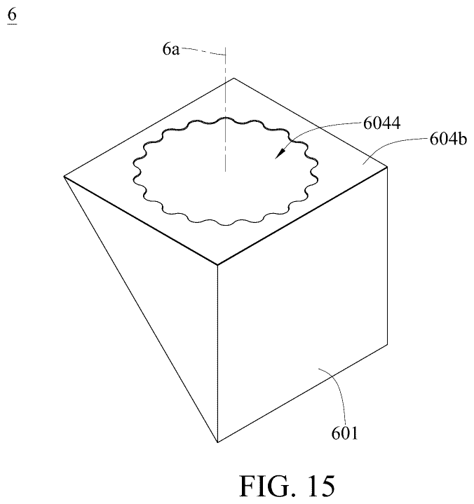

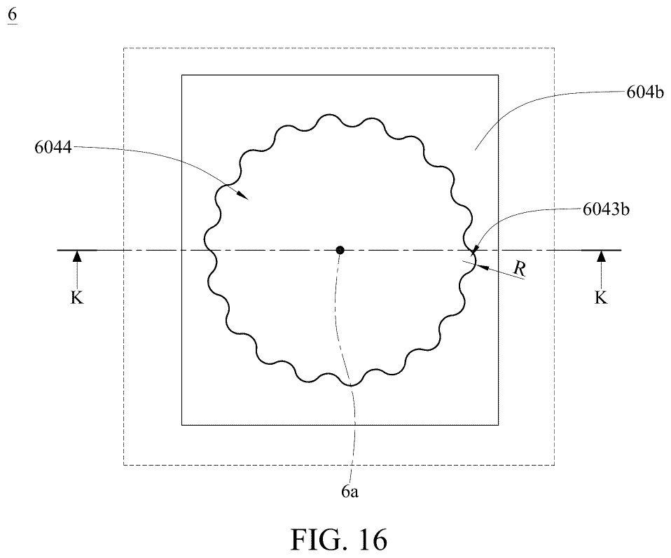

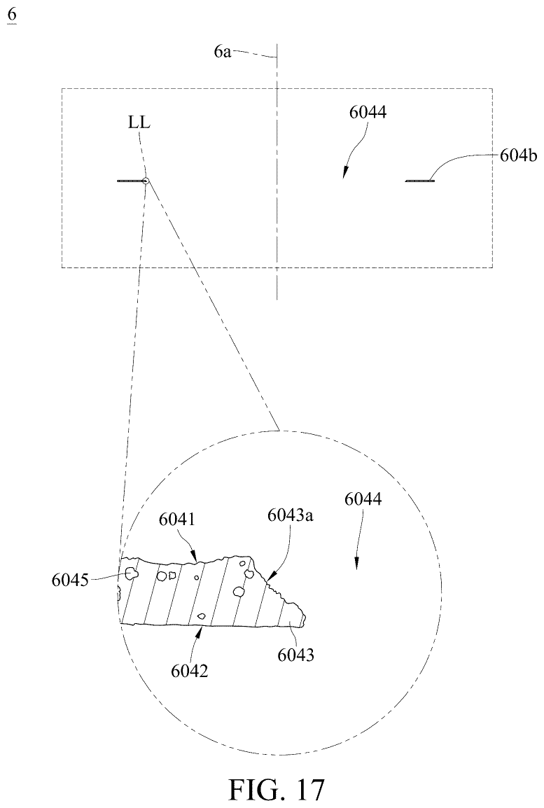

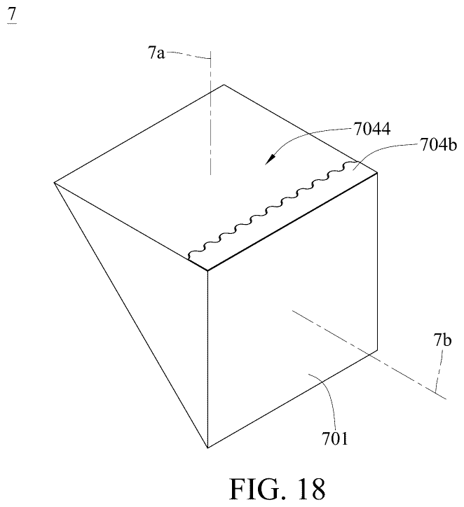

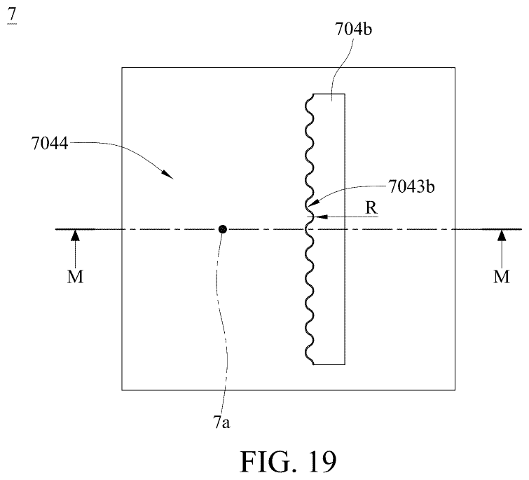

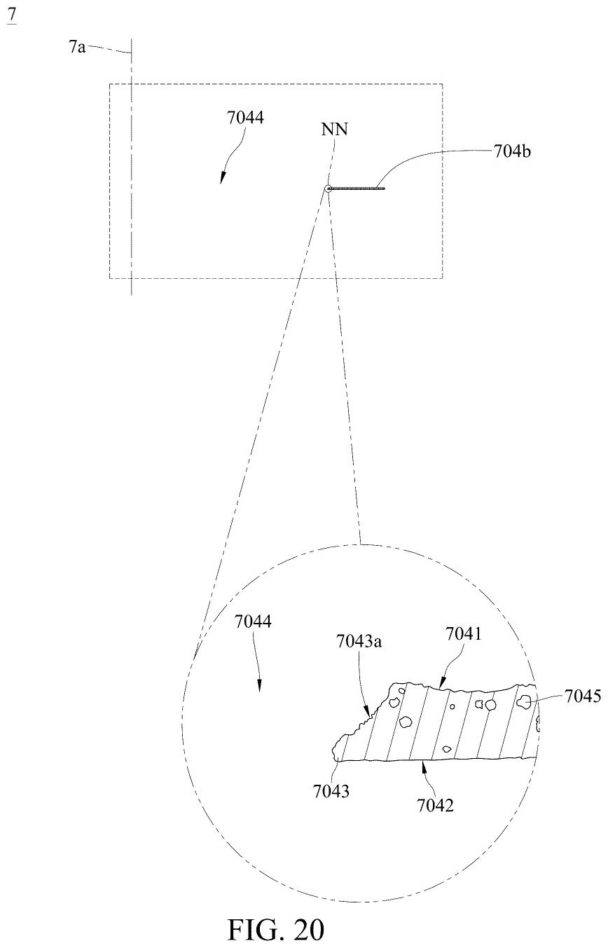

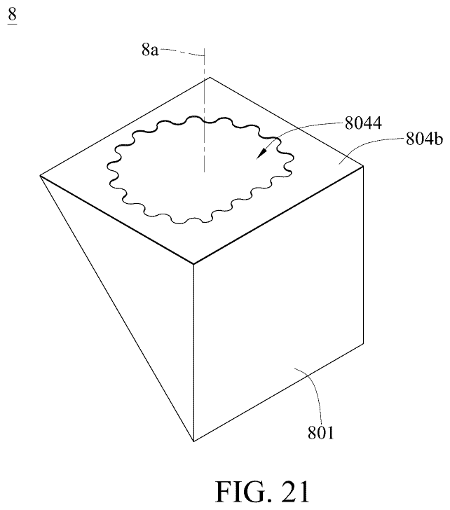

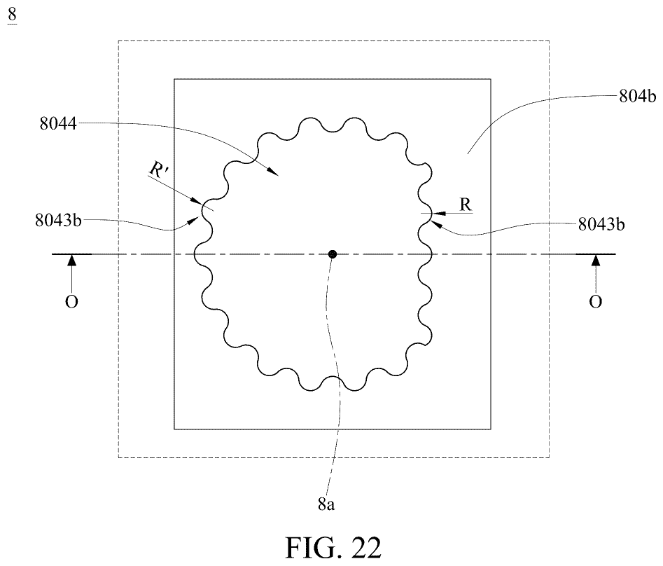

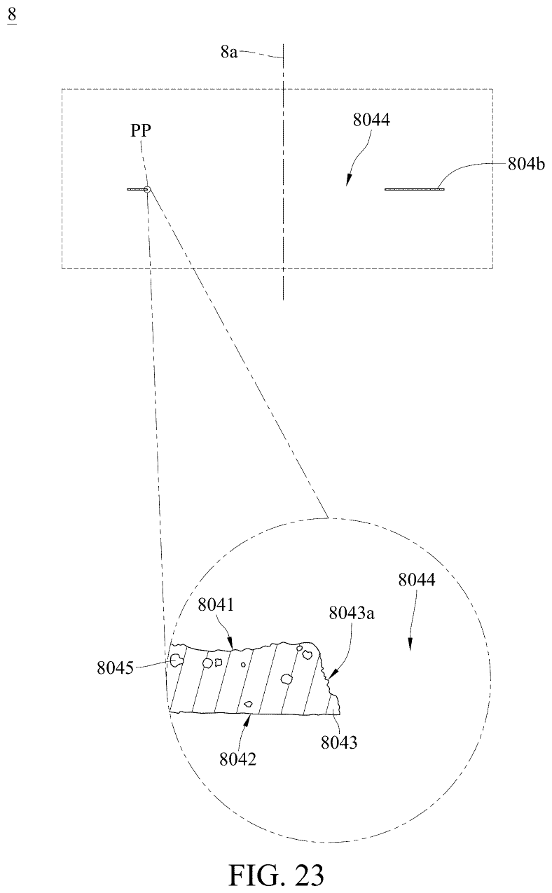

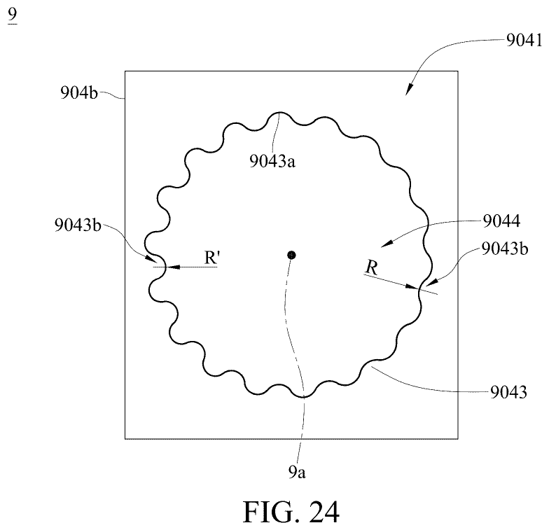

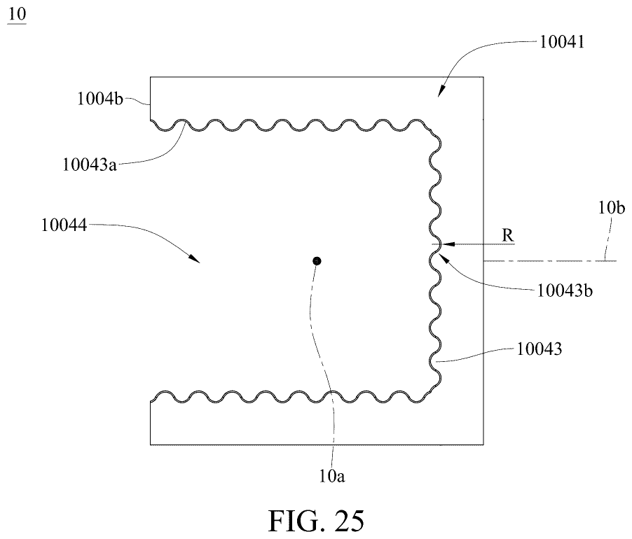

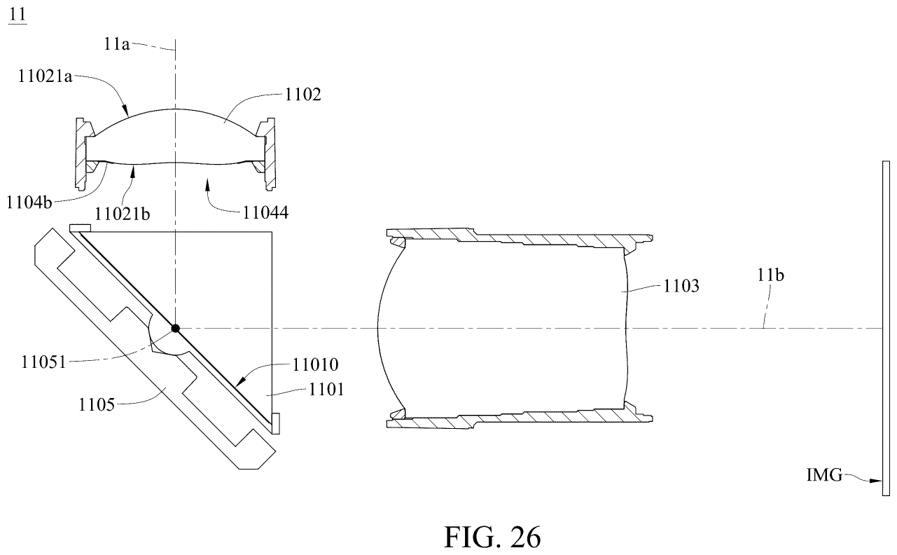

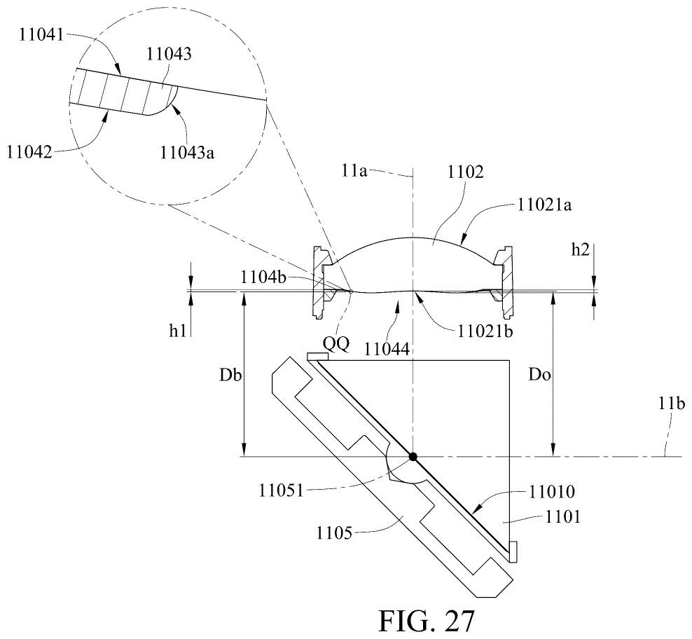

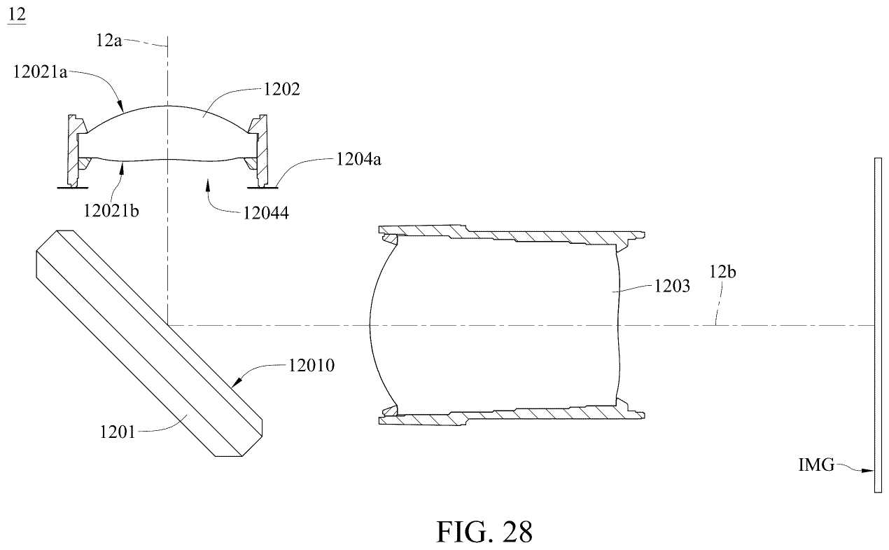

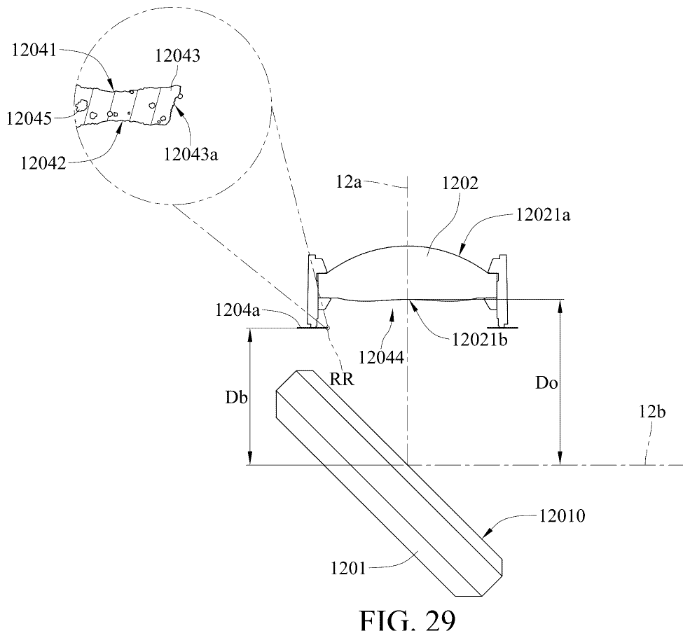

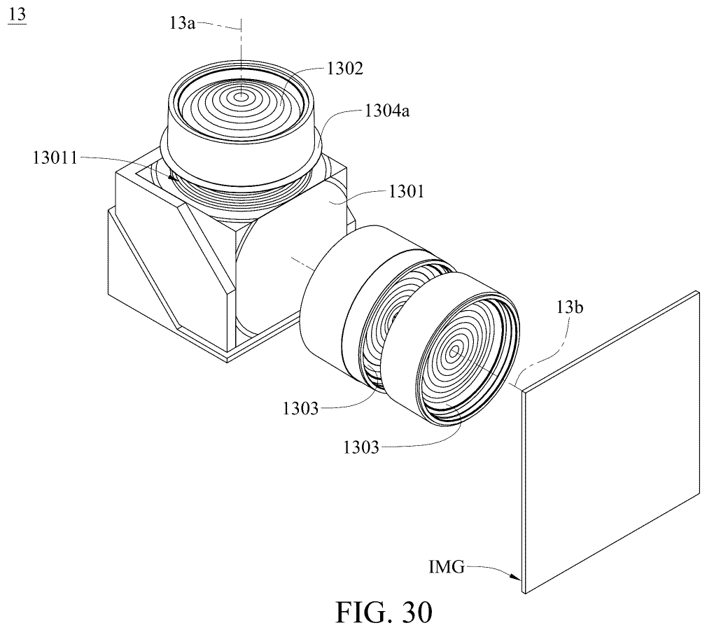

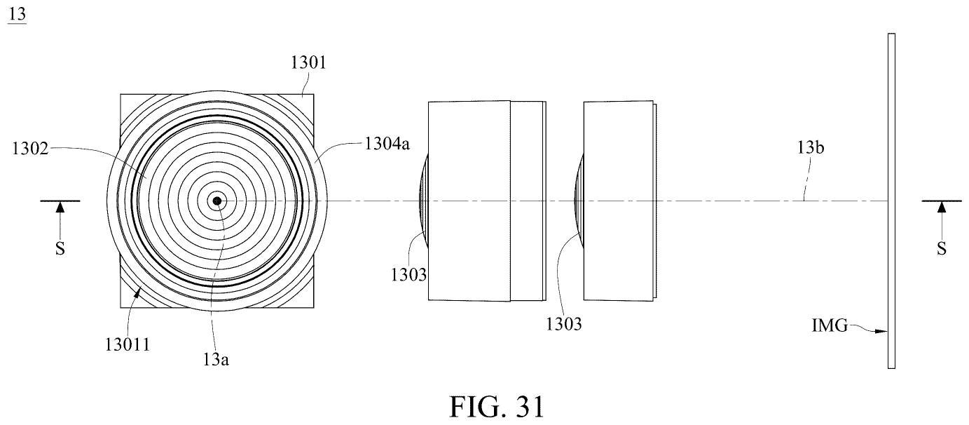

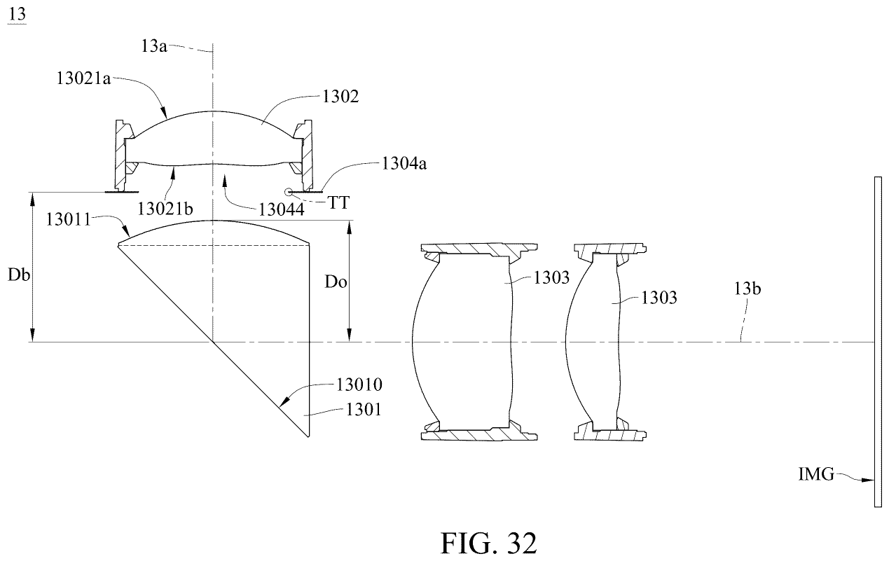

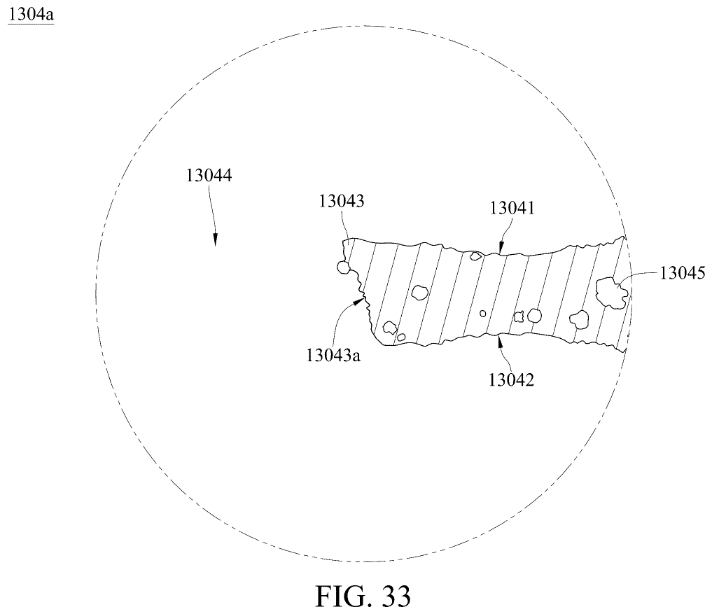

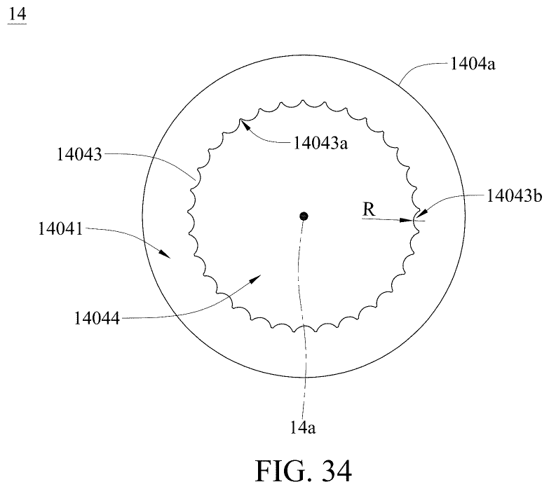

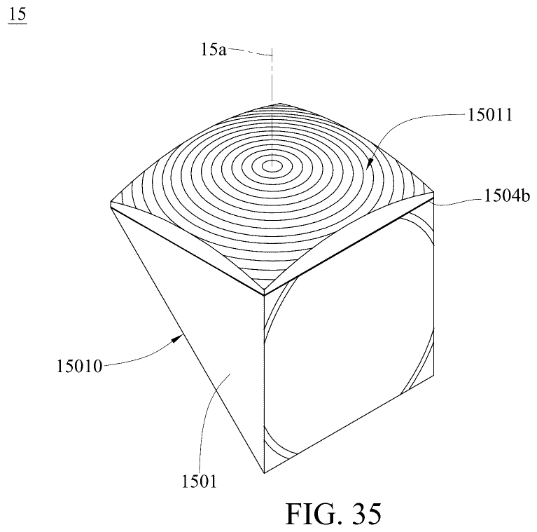

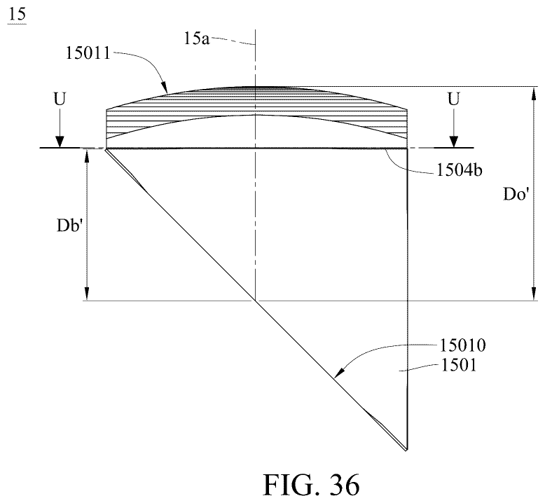

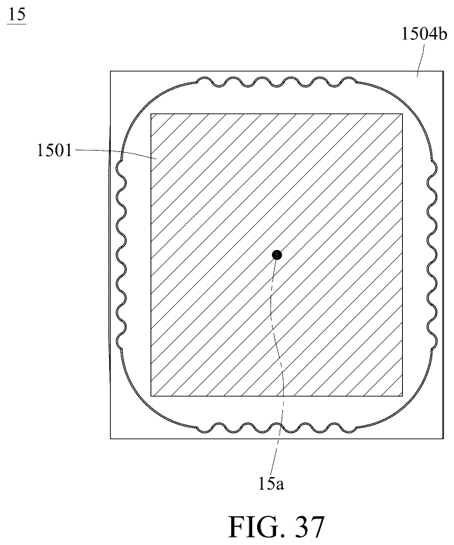

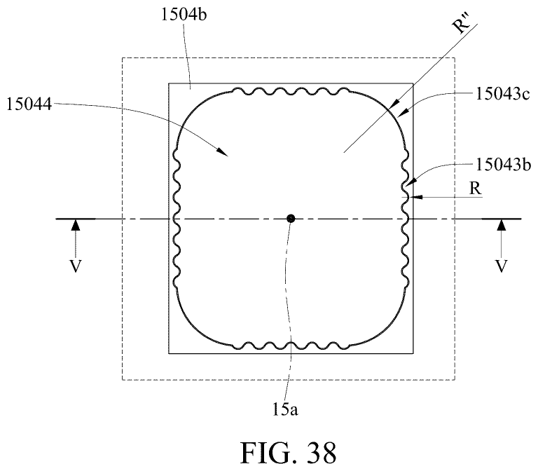

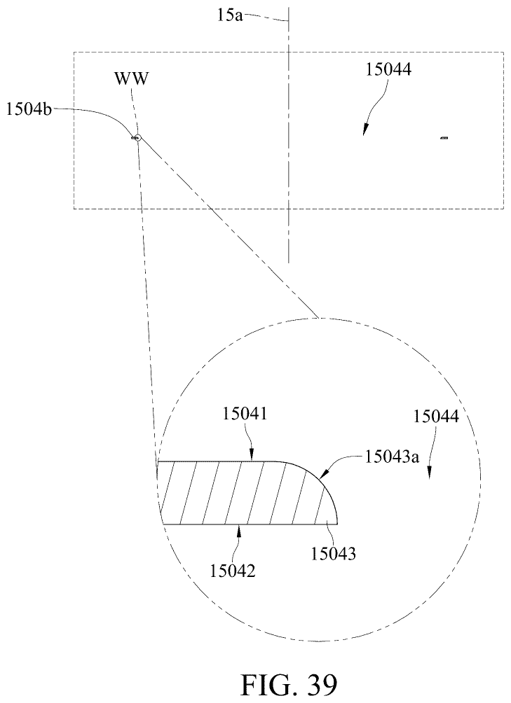

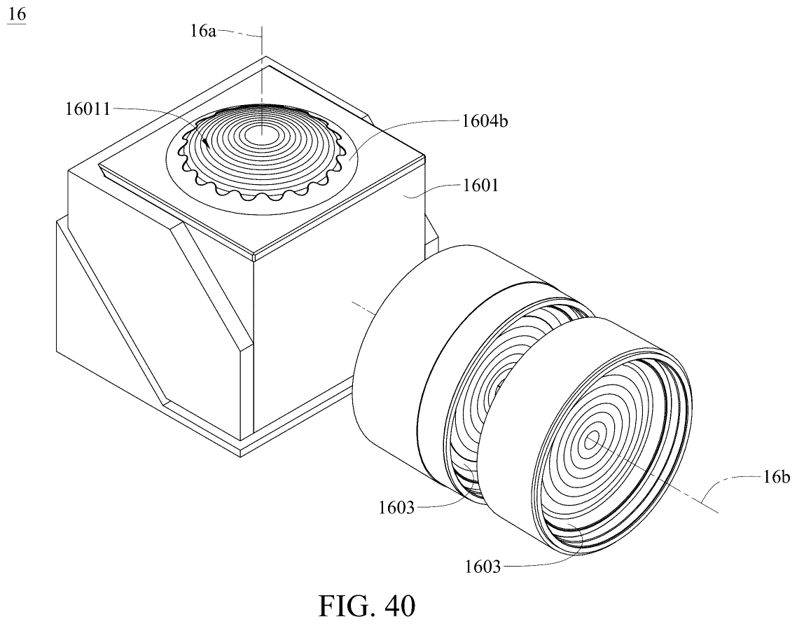

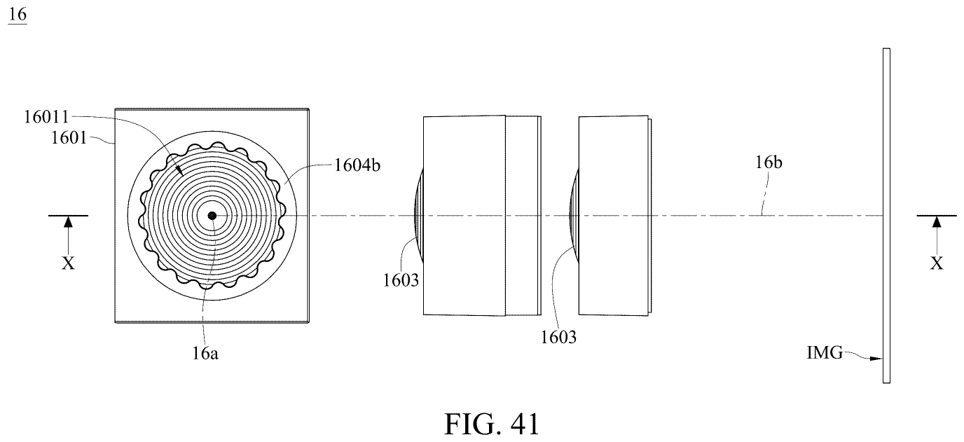

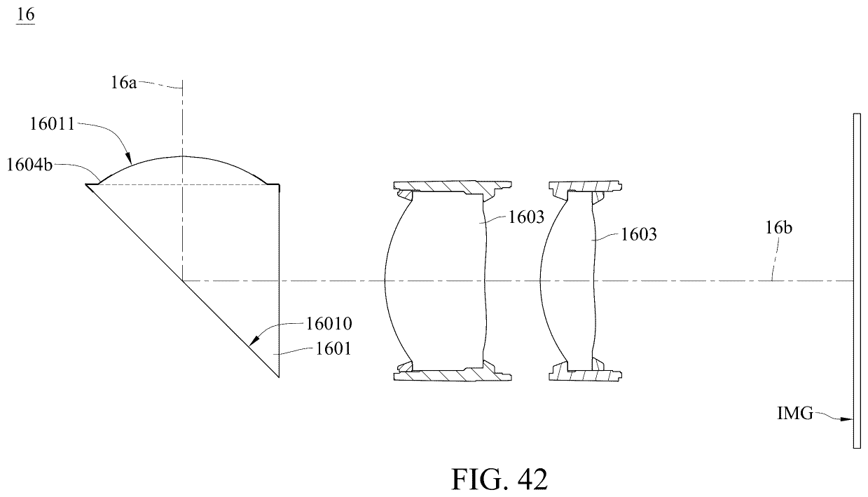

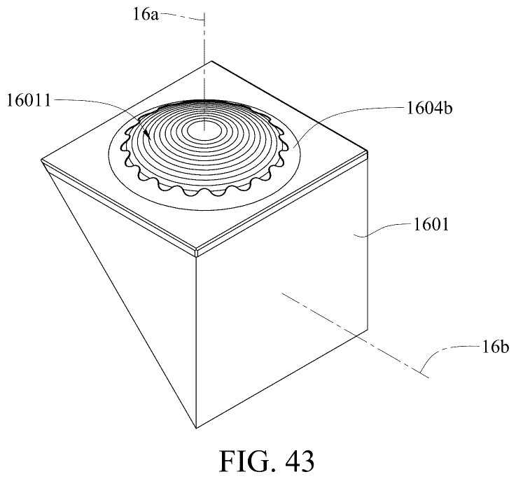

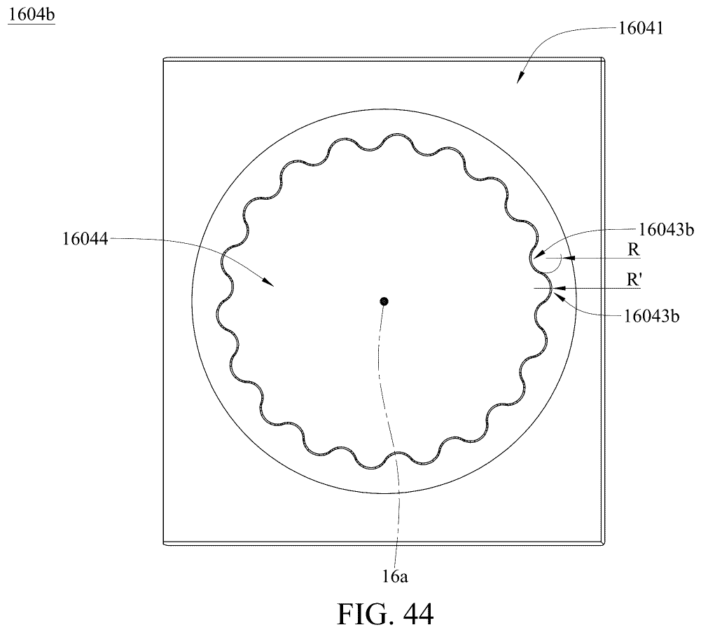

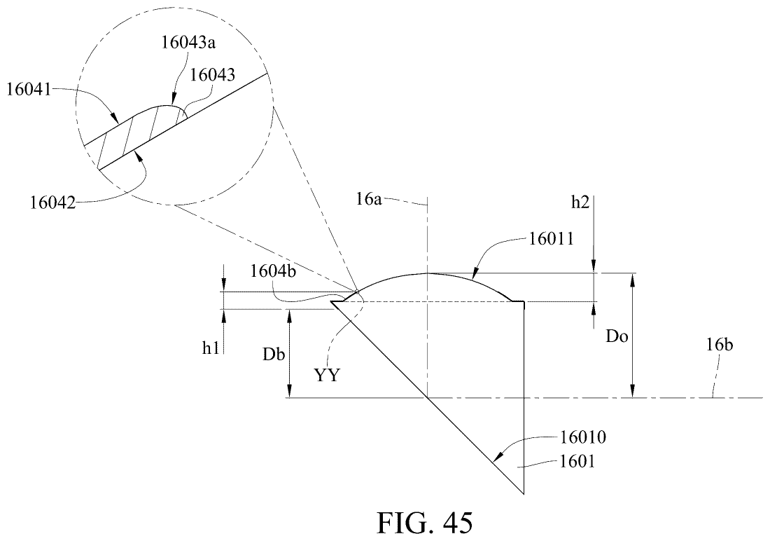

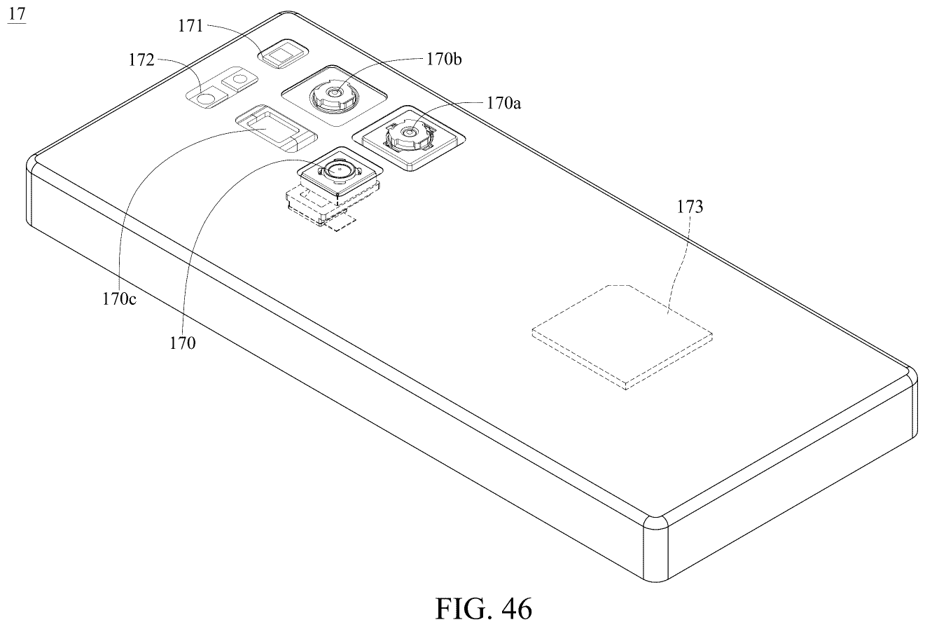

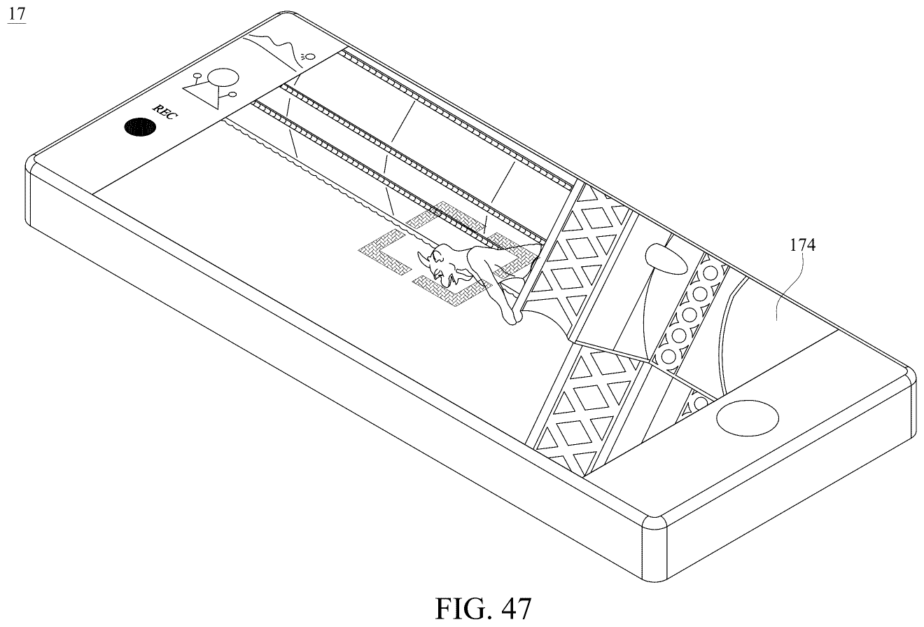

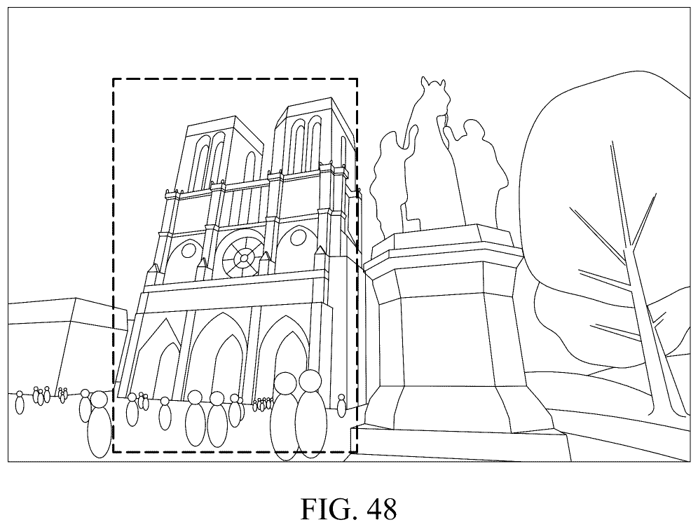

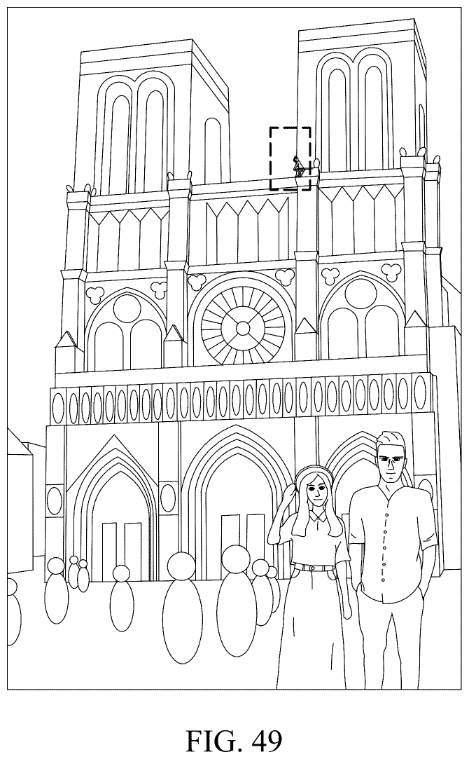

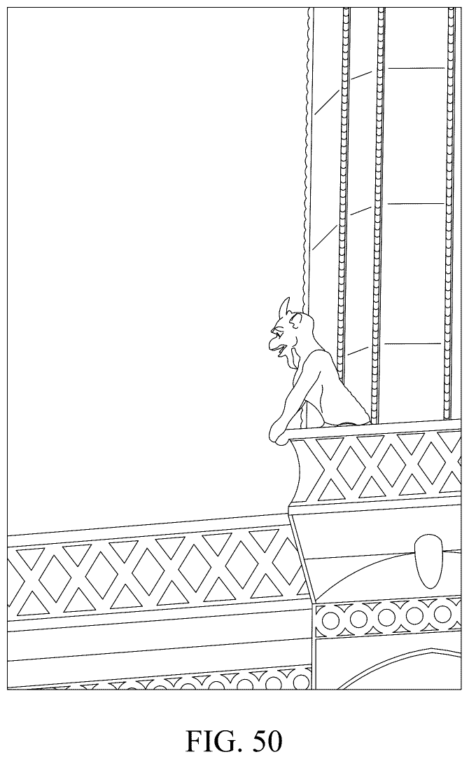

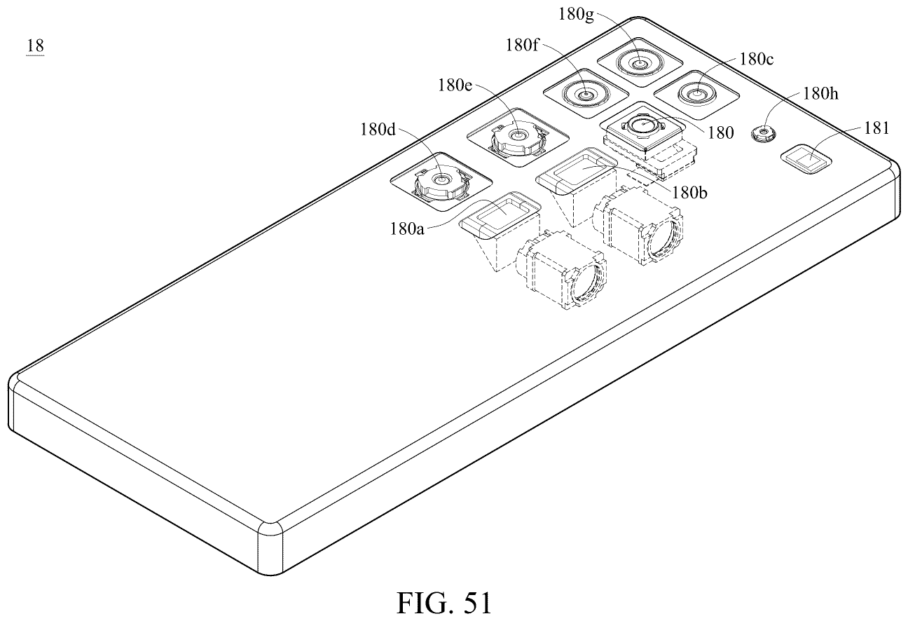

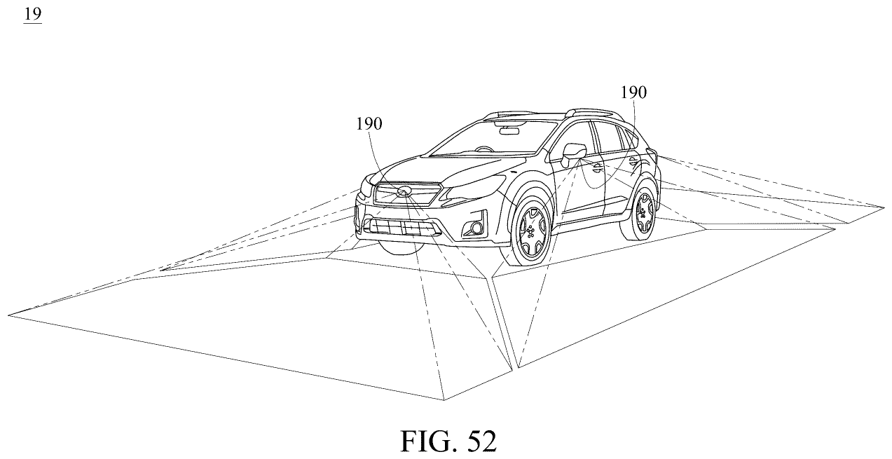

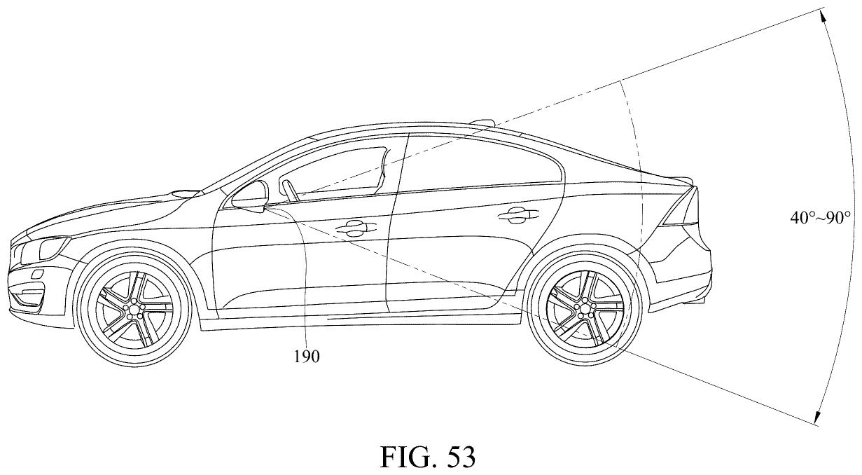

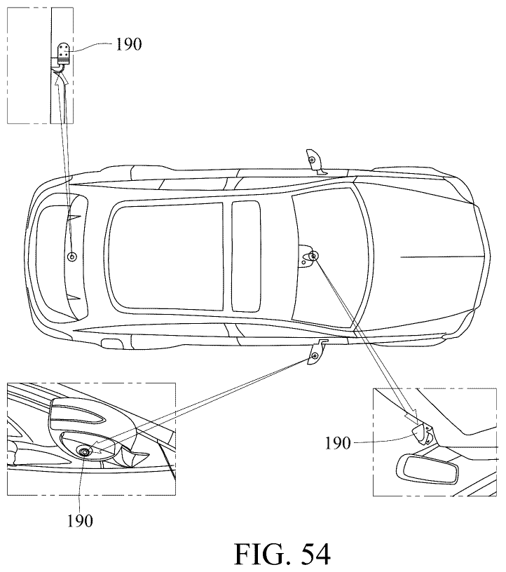

Please refer to FIG. 7 to FIG. 8, where FIG. 7 is a top view of a light-blocking sheet of an optical path folding camera module according to the 3rd embodiment of the present disclosure, and FIG. 8 is a cross-sectional view of the light-blocking sheet along E-E line in FIG. 7, with an enlarged view of FF region thereof.

In the following, a light-blocking sheet 304a, which is provided in this embodiment and can be used to replace the light-blocking sheet 104a in the 1st embodiment, would be illustrated. Please be noted that an optical path folding camera module 3 provided in this embodiment is similar to the optical path folding camera module 1 of the 1st embodiment, and therefore only differences between them, as well as necessary description, would be stated below.

The light-blocking sheet 304a includes an object-side surface 3041, an image-side surface 3042, a light-blocking part 3043 and a light opening 3044. The object-side surface 3041 faces towards the object side. The image-side surface 3042 is disposed opposite to the object-side surface 3041. The light-blocking part 3043 is connected to the object-side surface 3041 and the image-side surface 3042.

The light-blocking part 3043 has a light-blocking surface 3043a surrounding the first optical axis 3a. The light opening 3044 is defined by the light-blocking surface 3043a.

The light-blocking surface 3043a continuously extends towards the object-side surface 3041 and the image-side surface 3042 without any crack. It can also be considered that the light-blocking surface 3043a extends from the object-side surface 3041 to the image-side surface 3042 in a continuous and no-crack manner. The light-blocking surface 3043a is arranged gradually away from the first optical axis 3a along a direction parallel to the first optical axis 3a and from the object side to the image side.

The light-blocking sheet 304a further includes a plurality of specifically-shaped additives 3045. The specifically-shaped additives 3045 are uniformly distributed within the light-blocking sheet 304a.

Please refer to FIG. 7, the light-blocking part 3043 further has a plurality of curved structures 3043b in a direction perpendicular to the first optical axis 3a. The curved structures 3043b extend along a direction from the light-blocking surface 3043a to the first optical axis 3a. The curved structures 3043b are integrally formed with the light-blocking part 3043, but the present disclosure is not limited thereto.

When a curvature radius of the curved structures 3043b at a side thereof close to the object-side surface 3041 in a direction perpendicular to the first optical axis 3a is R, the following condition is satisfied: R=0.24 mm.

As shown in FIG. 7, the curved structures 3043b extending along a direction perpendicular to the first optical axis 3a are arranged in a loop along the whole contour of the inner edge of the light-blocking part 3043. However, the present disclosure is not limited thereto. Please continue to refer to the 4th embodiment.

### 4th Embodiment

Please refer to FIG. 9 to FIG. 10, where FIG. 9 is a top view of a light-blocking sheet of an optical path folding camera module according to the 4th embodiment of the present disclosure, and FIG. 10 is a cross-sectional view of the light-blocking sheet along G-G line in FIG. 9, with an enlarged view of HH region thereof.

In the following, a light-blocking sheet 404a, which is provided in this embodiment and can be used to replace the light-blocking sheet 104a in the 1st embodiment, would be illustrated. Please be noted that an optical path folding camera module 4 provided in this embodiment is similar to the optical path folding camera module 1 of the 1st embodiment, and therefore only differences between them, as well as necessary description, would be stated below.

The light-blocking sheet 404a includes an object-side surface 4041, an image-side surface 4042, a light-blocking part 4043 and a light opening 4044. The object-side surface 4041 faces towards the object side. The image-side surface 4042 is disposed opposite to the object-side surface 4041. The light-blocking part 4043 is connected to the object-side surface 4041 and the image-side surface 4042.

The light-blocking part 4043 has a light-blocking surface 4043a surrounding the first optical axis 4a. The light opening 4044 is defined by the light-blocking surface 4043a.

The light-blocking surface 4043a continuously extends towards the object-side surface 4041 and the image-side surface 4042 without any crack. It can also be considered that the light-blocking surface 4043a extends from the object-side surface 4041 to the image-side surface 4042 in a continuous and no-crack manner. The light-blocking surface 4043a is arranged gradually close to the first optical axis 4a and then gradually away from the first optical axis 4a along a direction parallel to the first optical axis 4a and from the object side to the image side.

The light-blocking sheet 404a further includes a plurality of specifically-shaped additives 4045. The specifically-shaped additives 4045 are uniformly distributed within the light-blocking sheet 404a.

### 5th Embodiment

Please refer to FIG. 11 to FIG. 14, where FIG. 11 is a perspective view of an optical path folding camera module according to the 5th embodiment of the present disclosure, FIG. 12 is a top view of the optical path folding camera module in FIG. 11, FIG. 13 is a cross-sectional view of the optical path folding camera module along I-I line in FIG. 12, and FIG. 14 is an enlarged view of JJ region in FIG. 13.

An optical path folding camera module 5 provided in this embodiment has, in order from an object side to an image side, a first optical axis 5a and a second optical axis 5b.

The optical path folding camera module 5 includes a light folding element 501, an object-side lens element 502 and an image-side lens element 503. The light folding element 501 is a prism, but the present disclosure is not limited thereto. The object-side lens element 502 is a single lens element, the image-side lens element 503 is a single lens group, but the present disclosure is not limited thereto. Please be noted that part of the contours of the object-side lens element 502 and the image-side lens element 503 is omitted.

The light folding element 501 has a reflection surface 5010. The reflection surface 5010 deflects the first optical axis 5a to the second optical axis 5b. The first optical axis 5a is disposed through the object-side lens element 502, and the second optical axis 5b is disposed through the image-side lens element 503 and extends to an image surface IMG.

The object-side lens element 502 has a plurality of optical surfaces 5021a and 5021b. The optical surfaces 5021a and 5021b are disposed corresponding to the reflection surface 5010 along the first optical axis 5a, and the first optical axis 5a is disposed through the optical surfaces 5021a and 5021b. It can also be considered that the optical surface 5021a faces away from the reflection surface 5010 along the first optical axis 5a, and the optical surface 5021b faces towards the reflection surface 5010 along the first optical axis 5a.

The optical path folding camera module 5 further includes a light-blocking layer 504b. The light-blocking layer 504b is disposed on an object side of the reflection surface 5010 and is disposed between the optical surfaces 5021a and 5021b and the reflection surface 5010. The light-blocking layer 504b is attached on the light-entering surface of the light folding element 501 close to the object-side lens element 502.

The light-blocking layer 504b includes an object-side surface 5041, an image-side surface 5042, a light-blocking part 5043 and a light opening 5044. The object-side surface 5041 faces towards the object side. The image-side surface 5042 is disposed opposite to the object-side surface 5041 and faces towards the reflection surface 5010. The light-blocking part 5043 is connected to the object-side surface 5041 and the image-side surface 5042. The light-blocking part 5043 is disposed facing towards the first optical axis 5a. The light-blocking part 5043 is located closer to the first optical axis 5a than the image-side lens element 503.

The light-blocking part 5043 has a light-blocking surface 5043a surrounding the first optical axis 5a. The light opening 5044 is defined by the light-blocking surface 5043a of the light-blocking part 5043.

The light-blocking surface 5043a of the light-blocking part 5043 continuously extends towards the object-side surface 5041 and the image-side surface 5042 without any crack. It can also be considered that the light-blocking surface 5043a extends from the object-side surface 5041 to the image-side surface 5042 in a continuous and no-crack manner. The light-blocking surface 5043a is arranged gradually close to the first optical axis 5a along a direction parallel to the first optical axis 5a and from the object side to the image side.

The light-blocking layer 504b further includes a plurality of specifically-shaped additives 5045. The specifically-shaped additives 5045 are uniformly distributed within the light-blocking layer 504b.

When a distance along the first optical axis 5a between the reflection surface 5010 and the image-side surface 5042 of the light-blocking layer 504b closest to the reflection surface 5010 is Db, and a distance along the first optical axis 5a between the reflection surface 5010 and the optical surface 5021b of the optical surfaces 5021a and 5021b closest to the reflection surface 5010 is Do, the following conditions are satisfied: Db=2.88 mm; Do=4.96 mm; and Db/Do=0.58. Please be noted that both Db and Do are measured based on the positions where the reflection surface 5010 and the optical surface 5021b intersect the first optical axis 5a

The light-blocking layer 504b of this embodiment can be replaced with different forms of light-blocking layers, provided that the imaging remains unaffected. Please continue to refer to the 6th embodiment.

### 6th Embodiment

Please refer to FIG. 15 to FIG. 17, where FIG. 15 is a perspective view of a light folding element and a light-blocking layer of an optical path folding camera module according to the 6th embodiment of the present disclosure, FIG. 16 is a top view of the light-blocking layer in FIG. 15, and FIG. 17 is a cross-sectional view of the light-blocking layer along K-K line in FIG. 16, with an enlarged view of LL region thereof. In the following, a light-blocking layer 604b, which is provided in this embodiment and can be used to replace the light-blocking layer 504b in the 5th embodiment, would be illustrated. Please be noted that an optical path folding camera module 6 provided in this embodiment is similar to the optical path folding camera module 5 of the 5th embodiment, and therefore only differences between them, as well as necessary description, would be stated below.

The light-blocking layer 604b is attached on the light-entering surface of the light folding element 601.

The light-blocking layer 604b includes an object-side surface 6041, an image-side surface 6042, a light-blocking part 6043 and a light opening 6044. The object-side surface 6041 faces towards the object side. The image-side surface 6042 is disposed opposite to the object-side surface 6041. The light-blocking part 6043 is connected to the object-side surface 6041 and the image-side surface 6042.

The light-blocking part 6043 has a light-blocking surface 6043a surrounding the first optical axis 6a. The light opening 6044 is defined by the light-blocking surface 6043a of the light-blocking part 6043.

The light-blocking surface 6043a of the light-blocking part 6043 continuously extends towards the object-side surface 6041 and the image-side surface 6042 without any crack. It can also be considered that the light-blocking surface 6043a extends from the object-side surface 6041 to the image-side surface 6042 in a continuous and no-crack manner. The light-blocking surface 6043a is arranged gradually close to the first optical axis 6a along a direction parallel to the first optical axis 6a and from the object side to the image side.

The light-blocking layer 604b further includes a plurality of specifically-shaped additives 6045. The specifically-shaped additives 6045 are uniformly distributed within the light-blocking layer 604b.

Please refer to FIG. 15 and FIG. 16, the light-blocking part 6043 further has a plurality of curved structures 6043b in a direction perpendicular to the first optical axis 6a. The curved structures 6043b extend along a direction from the light-blocking surface 6043a to the first optical axis 6a. The curved structures 6043b are integrally formed with the light-blocking part 6043, but the present disclosure is not limited thereto.

When a curvature radius of the curved structures 6043b at a side thereof close to the object-side surface 6041 in a direction perpendicular to the first optical axis 6a is R, the following condition is satisfied: R=0.25 mm.

As shown in FIG. 15 and FIG. 16, the curved structures 6043b extending along a direction perpendicular to the first optical axis 6a are arranged in a loop along the whole contour of the inner edge of the light-blocking part 6043. However, the present disclosure is not limited thereto. Please continue to refer to the 7th embodiment.

### 7th Embodiment

Please refer to FIG. 18 to FIG. 20, where FIG. 18 is a perspective view of a light folding element and a light-blocking layer of an optical path folding camera module according to the 7th embodiment of the present disclosure, FIG. 19 is a top view of the light-blocking layer in FIG. 18, and FIG. 20 is a cross-sectional view of the light-blocking layer along M-M line in FIG. 19, with an enlarged view of NN region thereof. In the following, a light-blocking layer 704b, which is provided in this embodiment and can be used to replace the light-blocking layer 504b in the 5th embodiment, would be illustrated. Please be noted that an optical path folding camera module 7 provided in this embodiment is similar to the optical path folding camera module 5 of the 5th embodiment, and therefore only differences between them, as well as necessary description, would be stated below.

The light-blocking layer 704b is attached on the light-entering surface of the light folding element 701.

The light-blocking layer 704b includes an object-side surface 7041, an image-side surface 7042, a light-blocking part 7043 and a light opening 7044. The object-side surface 7041 faces towards the object side. The image-side surface 7042 is disposed opposite to the object-side surface 7041. The light-blocking part 7043 is connected to the object-side surface 7041 and the image-side surface 7042.

The light-blocking part 7043 is substantially in a long shape. The light-blocking part 7043 has a light-blocking surface 7043a facing towards the first optical axis 7a. The light opening 7044 is defined by the light-blocking surface 7043a of the light-blocking part 7043.

The light-blocking surface 7043a of the light-blocking part 7043 continuously extends towards the object-side surface 7041 and the image-side surface 7042 without any crack. It can also be considered that the light-blocking surface 7043a extends from the object-side surface 7041 to the image-side surface 7042 in a continuous and no-crack manner. The light-blocking surface 7043a is arranged gradually close to the first optical axis 7a along a direction parallel to the first optical axis 7a and from the object side to the image side.

The light-blocking layer 704b further includes a plurality of specifically-shaped additives 7045. The specifically-shaped additives 7045 are uniformly distributed within the light-blocking layer 704b.

Please refer to FIG. 18 and FIG. 19, the light-blocking part 7043 further has a plurality of curved structures 7043b in a direction perpendicular to the first optical axis 7a. The curved structures 7043b extend along a direction from the light-blocking surface 7043a to the first optical axis 7a. The curved structures 7043b are integrally formed with the light-blocking part 7043, but the present disclosure is not limited thereto.

When a curvature radius of the curved structures 7043b at a side thereof close to the object-side surface 7041 in a direction perpendicular to the first optical axis 7a is R, the following condition is satisfied: R=0.16 mm.

As shown in FIG. 18 and FIG. 19, the curved structures 7043b are arranged substantially along a straight line in a direction perpendicular to the first optical axis 7a and the second optical axis 7b. However, the present disclosure is not limited thereto. Please continue to refer to the 8th embodiment.

### 8th Embodiment

Please refer to FIG. 21 to FIG. 23, where FIG. 21 is a perspective view of a light folding element and a light-blocking layer of an optical path folding camera module according to the 8th embodiment of the present disclosure, FIG. 22 is a top view of the light-blocking layer in FIG. 21, and FIG. 23 is a cross-sectional view of the light-blocking layer along O—O line in FIG. 22, with an enlarged view of PP region thereof. In the following, a light-blocking layer 804b, which is provided in this embodiment and can be used to replace the light-blocking layer 504b in the 5th embodiment, would be illustrated. Please be noted that an optical path folding camera module 8 provided in this embodiment is similar to the optical path folding camera module 5 of the 5th embodiment, and therefore only differences between them, as well as necessary description, would be stated below.

The light-blocking layer 804b is attached on the light-entering surface of the light folding element 801.

The light-blocking layer 804b includes an object-side surface 8041, an image-side surface 8042, a light-blocking part 8043 and a light opening 8044. The object-side surface 8041 faces towards the object side. The image-side surface 8042 is disposed opposite to the object-side surface 8041. The light-blocking part 8043 is connected to the object-side surface 8041 and the image-side surface 8042.

The light-blocking part 8043 has a light-blocking surface 8043a facing towards the first optical axis 8a. The light opening 8044 is defined by the light-blocking surface 8043a of the light-blocking part 8043.

The light-blocking surface 8043a of the light-blocking part 8043 continuously extends towards the object-side surface 8041 and the image-side surface 8042 without any crack. It can also be considered that the light-blocking surface 8043a extends from the object-side surface 8041 to the image-side surface 8042 in a continuous and no-crack manner. The light-blocking surface 8043a is arranged gradually close to the first optical axis 8a along a direction parallel to the first optical axis 8a and from the object side to the image side.

The light-blocking layer 804b further includes a plurality of specifically-shaped additives 8045. The specifically-shaped additives 8045 are uniformly distributed within the light-blocking layer 804b.

Please refer to FIG. 21 and FIG. 22, the light-blocking part 8043 further has a plurality of curved structures 8043b in a direction perpendicular to the first optical axis 8a. The curved structures 8043b extend along a direction from the light-blocking surface 8043a to the first optical axis 8a. The curved structures 8043b are integrally formed with the light-blocking part 8043, but the present disclosure is not limited thereto.

When curvature radii of the curved structures 8043b at a side thereof close to the object-side surface 8041 in a direction perpendicular to the first optical axis 8a are R and R′, the following conditions are satisfied: R=0.20 mm; and R′=0.22 mm, as shown in FIG. 22.

As shown in FIG. 21 and FIG. 22, the curved structures 8043b extending along a direction perpendicular to the first optical axis 8a are arranged in a loop along the whole contour of the inner edge of the light-blocking part 8043, wherein the curved structures 8043b at a side close to the light-exiting surface of the light folding element 801 are arranged substantially along a straight line (i.e., the side where the curvature R is existed), and the curved structures 8043b at each of the other three sides are arranged substantially along an arc line (i.e., the side where the curvature R′ is existed). However, the present disclosure is not limited thereto. Please continue to refer to the 9th embodiment.

### 9th Embodiment

Please refer to FIG. 24, which is a top view of a light folding element and a light-blocking layer of an optical path folding camera module according to the 9th embodiment of the present disclosure.

In the following, a light-blocking layer 904b, which is provided in this embodiment and can be used to replace the light-blocking layer 804b in the 8th embodiment, would be illustrated. Please be noted that an optical path folding camera module 9 provided in this embodiment is similar to the optical path folding camera module 8 of the 8th embodiment, and therefore only differences between them, as well as necessary description, would be stated below.

The light-blocking part 9043 has a light-blocking surface 9043a facing towards the first optical axis 9a. The light opening 9044 is defined by the light-blocking surface 9043a of the light-blocking part 9043.

Please refer to FIG. 24, the light-blocking part 9043 further has a plurality of curved structures 9043b in a direction perpendicular to the first optical axis 9a. The curved structures 9043b extend along a direction from the light-blocking surface 9043a to the first optical axis 9a. The curved structures 9043b are integrally formed with the light-blocking part 9043, but the present disclosure is not limited thereto.

When curvature radii of the curved structures 9043b at a side thereof close to the object-side surface 9041 in a direction perpendicular to the first optical axis 9a are R and R′, the following conditions are satisfied: R=0.33 mm; and R′=0.21 mm.

As shown in FIG. 24, the curved structures 9043b have various curvature radii, and therefore only curvature radii with the smallest value R and the largest value R′ are provided herein for simplicity. However, the present disclosure is not limited thereto.

As shown in FIG. 24, the curved structure 9043b extending along a direction perpendicular to the first optical axis 9a are arranged in a loop along the whole contour of the inner edge of the light-blocking part 9043. However, the present disclosure is not limited thereto. Please continue to refer to the 10th embodiment.

### 10th Embodiment

Please refer to FIG. 25, which is a top view of a light folding element and a light-blocking layer of an optical path folding camera module according to the 10th embodiment of the present disclosure.

In the following, a light-blocking layer 1004b, which is provided in this embodiment and can be used to replace the light-blocking layer 804b in the 8th embodiment, would be illustrated. Please be noted that an optical path folding camera module 10 provided in this embodiment is similar to the optical path folding camera module 8 of the 8th embodiment, and therefore only differences between them, as well as necessary description, would be stated below.

The light-blocking part 10043 is located at three sides of the first optical axis 10a. The light-blocking part 10043 has a light-blocking surface 10043a facing towards the first optical axis 10a. The light opening 10044 is defined by the light-blocking surface 10043a of the light-blocking part 10043.

Please refer to FIG. 25, the light-blocking part 10043 further has a plurality of curved structures 10043b in a direction perpendicular to the first optical axis 10a. The curved structures 10043b extend along a direction from the light-blocking surface 10043a to the first optical axis 10a. The curved structures 10043b are integrally formed with the light-blocking part 10043, but the present disclosure is not limited thereto.

When a curvature radius of the curved structures 10043b at a side thereof close to the object-side surface 10041 in a direction perpendicular to the first optical axis 10a is R, the following condition is satisfied: R=0.16 mm.

As shown in FIG. 25, the curved structure 10043b extending along a direction perpendicular to the first optical axis 10a are arranged along the contour of the inner edge of the light-blocking part 10043, wherein the curved structure 10043b are substantially linearly arranged on two opposite sides of the light opening 10044 in a direction parallel to the second optical axis 10b and one side of the light opening 10044 in a direction perpendicular to the second optical axis 10b. However, the present disclosure is not limited thereto.

### 11th Embodiment

Please refer to FIG. 26 to FIG. 27, where FIG. 26 is a cross-sectional view of an optical path folding camera module according to the 11th embodiment of the present disclosure, and FIG. 27 is a partial view of the optical path folding camera module in FIG. 26, with an enlarged view of QQ region thereof.

An optical path folding camera module 11 provided in this embodiment has, in order from an object side to an image side, a first optical axis 11a and a second optical axis 11b.

The optical path folding camera module 11 includes a light folding element 1101, an object-side lens element 1102 and an image-side lens element 1103. The light folding element 1101 is a prism, but the present disclosure is not limited thereto. The object-side lens element 1102 is a single lens element, the image-side lens element 1103 is a single lens group, but the present disclosure is not limited thereto. Please be noted that part of the contours of the object-side lens element 1102 and the image-side lens element 1103 is omitted.

The light folding element 1101 has a reflection surface 11010. The reflection surface 11010 deflects the first optical axis 11a to the second optical axis 11b. The first optical axis 11a is disposed through the object-side lens element 1102, and the second optical axis 11b is disposed through the image-side lens element 1103 and extends to an image surface IMG.

The object-side lens element 1102 has a plurality of optical surfaces 11021a and 11021b. The optical surfaces 11021a and 11021b are disposed corresponding to the reflection surface 11010 along the first optical axis 11a, and the first optical axis 11a is disposed through the optical surfaces 11021a and 11021b. It can also be considered that the optical surface 11021a faces away from the reflection surface 11010 along the first optical axis 11a, and the optical surface 11021b faces towards the reflection surface 11010 along the first optical axis 11a.

The optical path folding camera module 11 further includes a light-blocking layer 1104b. The light-blocking layer 1104b is disposed on an object side of the reflection surface 11010 and is disposed between the optical surfaces 11021a and 11021b and the reflection surface 11010. The light-blocking layer 1104b is attached on the optical surface 11021b, and the light-blocking layer 1104b extends along a direction parallel to the first optical axis 11a and extends towards the first optical axis 11a.

The light-blocking layer 1104b includes an object-side surface 11041, an image-side surface 11042, a light-blocking part 11043 and a light opening 11044. The object-side surface 11041 faces towards the object side. The image-side surface 11042 is disposed opposite to the object-side surface 11041 and faces towards the reflection surface 11010. The light-blocking part 11043 is connected to the object-side surface 11041 and the image-side surface 11042. The light-blocking part 11043 is disposed facing towards the first optical axis 11a. The light-blocking part 11043 is located closer to the first optical axis 11a than the image-side lens element 1103.

The light-blocking part 11043 has a light-blocking surface 11043a surrounding the first optical axis 11a. The light opening 11044 is defined by the light-blocking surface 11043a of the light-blocking part 11043.

The light-blocking surface 11043a of the light-blocking part 11043 continuously extends towards the object-side surface 11041 and the image-side surface 11042 without any crack, and the light-blocking surface 11043a is arranged gradually away from the first optical axis 11a along a direction parallel to the first optical axis 11a and from the object side to the image side.

The optical path folding camera module 11 further includes a driving device 1105. The driving device 1105 provides the light folding element 1101 with a rotation axis 11051 and a degree of freedom rotating about the rotation axis 11051.

When a height of the light-blocking layer 1104b in a direction parallel to the first optical axis 11a is h1, and a height difference of the optical surface 11021b of the optical surfaces 11021a and 11021b where the light-blocking layer 1104b is attached in a direction parallel to the first optical axis 11a is h2, the following conditions are satisfied: h1=0.071 mm; h2=0.100 mm; and h1/h2=0.71.

When a distance along the first optical axis 11a between the reflection surface 11010 and the image-side surface 11042 of the light-blocking layer 1104b closest to the reflection surface 11010 is Db, and a distance along the first optical axis 11a between the reflection surface 11010 and the optical surface 11021b of the optical surfaces 11021a and 11021b closest to the reflection surface 11010 is Do, the following conditions are satisfied: Db=4.93 mm; Do=4.96 mm; and Db/Do=0.99. Please be noted that both Db and Do are measured based on the positions where the reflection surface 11010 and the optical surface 11021b intersect the first optical axis 11a.

### 12th Embodiment

Please refer to FIG. 28 to FIG. 29, where FIG. 28 is a cross-sectional view of an optical path folding camera module according to the 12th embodiment of the present disclosure, and FIG. 29 is a partial view of the optical path folding camera module in FIG. 28, with an enlarged view of RR region thereof.

An optical path folding camera module 12 provided in this embodiment has, in order from an object side to an image side, a first optical axis 12a and a second optical axis 12b.

The optical path folding camera module 12 includes a light folding element 1201, an object-side lens element 1202 and an image-side lens element 1203. The light folding element 1201 is a reflective mirror, but the present disclosure is not limited thereto. The object-side lens element 1202 is a single lens element, the image-side lens element 1203 is a single lens group, but the present disclosure is not limited thereto. Please be noted that part of the contours of the object-side lens element 1202 and the image-side lens element 1203 is omitted.

The light folding element 1201 has a reflection surface 12010. The reflection surface 12010 deflects the first optical axis 12a to the second optical axis 12b. The first optical axis 12a is disposed through the object-side lens element 1202, and the second optical axis 12b is disposed through the image-side lens element 1203 and extends to an image surface IMG.

The object-side lens element 1202 has a plurality of optical surfaces 12021a and 12021b. The optical surfaces 12021a and 12021b are disposed corresponding to the reflection surface 12010 along the first optical axis 12a, and the first optical axis 12a is disposed through the optical surfaces 12021a and 12021b. It can also be considered that the optical surface 12021a faces away from the reflection surface 12010 along the first optical axis 12a, and the optical surface 12021b faces towards the reflection surface 12010 along the first optical axis 12a.

The optical path folding camera module 12 further includes a light-blocking sheet 1204a. The light-blocking sheet 1204a is disposed on an object side of the reflection surface 12010 and is disposed between the optical surfaces 12021a and 12021b and the reflection surface 12010. The light-blocking sheet 1204a is spaced apart from the adjacent light folding element 1201 and the object-side lens element 1202 by a respective air gap.

The light-blocking sheet 1204a includes an object-side surface 12041, an image-side surface 12042, a light-blocking part 12043 and a light opening 12044. The object-side surface 12041 faces towards the object side. The image-side surface 12042 is disposed opposite to the object-side surface 12041 and faces towards the reflection surface 12010. The light-blocking part 12043 is connected to the object-side surface 12041 and the image-side surface 12042. The light-blocking part 12043 is disposed facing towards the first optical axis 12a. The light-blocking part 12043 is located closer to the first optical axis 12a than the image-side lens element 1203.

The light-blocking part 12043 has a light-blocking surface 12043a surrounding the first optical axis 12a. The light opening 12044 is defined by the light-blocking surface 12043a of the light-blocking part 12043.

The light-blocking surface 12043a of the light-blocking part 12043 continuously extends towards the object-side surface 12041 and the image-side surface 12042 without any crack. It can also be considered that the light-blocking surface 12043a extends from the object-side surface 12041 to the image-side surface 12042 in a continuous and no-crack manner. The light-blocking surface 12043a is arranged gradually away from the first optical axis 12a along a direction parallel to the first optical axis 12a and from the object side to the image side.

The light-blocking sheet 1204a further includes a plurality of specifically-shaped additives 12045. The specifically-shaped additives 12045 are uniformly distributed within the light-blocking sheet 1204a.

When a distance along the first optical axis 12a between the reflection surface 12010 and the image-side surface 12042 of the light-blocking sheet 1204a closest to the reflection surface 12010 is Db, and a distance along the first optical axis 12a between the reflection surface 12010 and the optical surface 12021b of the optical surfaces 12021a and 12021b closest to the reflection surface 12010 is Do, the following conditions are satisfied: Db=4.09 mm; Do=4.96 mm; and Db/Do=0.82. Please be noted that both Db and Do are measured based on the positions where the reflection surface 12010 and the optical surface 12021b intersect the first optical axis 12a.

### 13th Embodiment

Please refer to FIG. 30 to FIG. 33, where FIG. 30 is a perspective view of an optical path folding camera module according to the 13th embodiment of the present disclosure, FIG. 31 is a top view of the optical path folding camera module in FIG. 30, FIG. 32 is a cross-sectional view of the optical path folding camera module along S-S line in FIG. 31, and FIG. 33 is an enlarged view of TT region in FIG. 32.

An optical path folding camera module 13 provided in this embodiment has, in order from an object side to an image side, a first optical axis 13a and a second optical axis 13b.

The optical path folding camera module 13 includes a light folding element 1301, an object-side lens element 1302 and a plurality of image-side lens elements 1303. The light folding element 1301 is a prism, but the present disclosure is not limited thereto. The object-side lens element 1302 is a single lens element, the image-side lens elements 1303 are two sets of lens groups, but the present disclosure is not limited thereto. Please be noted that part of the contours of the object-side lens element 1302 and the image-side lens elements 1303 is omitted.

The light folding element 1301 has a reflection surface 13010. The reflection surface 13010 deflects the first optical axis 13a to the second optical axis 13b. The first optical axis 13a is disposed through the object-side lens element 1302, and the second optical axis 13b is disposed through the image-side lens elements 1303 and extends to an image surface IMG.

The object-side lens element 1302 has a plurality of optical surfaces 13021a and 13021b. The light folding element 1301 has an optical surface 13011. The optical surfaces 13021a, 13021b and 13011 are disposed corresponding to the reflection surface 13010 along the first optical axis 13a, and the first optical axis 13a is disposed through the optical surfaces 13021a, 13021b and 13011. It can also be considered that the optical surfaces 13021a and 13011 face away from the reflection surface 13010 along the first optical axis 13a, and the optical surface 13021b faces towards the reflection surface 13010 along the first optical axis 13a.

The optical path folding camera module 13 further includes a light-blocking sheet 1304a. The light-blocking sheet 1304a is disposed on an object side of the reflection surface 13010 and is disposed between the optical surfaces 13021a and 13021b and the reflection surface 13010. The light-blocking sheet 1304a is spaced apart from the adjacent light folding element 1301 and the object-side lens element 1302 by a respective air gap.

The light-blocking sheet 1304a includes an object-side surface 13041, an image-side surface 13042, a light-blocking part 13043 and a light opening 13044. The object-side surface 13041 faces towards the object side. The image-side surface 13042 is disposed opposite to the object-side surface 13041 and faces towards the reflection surface 13010. The light-blocking part 13043 is connected to the object-side surface 13041 and the image-side surface 13042. The light-blocking part 13043 is disposed facing towards the first optical axis 13a. The light-blocking part 13043 is located closer to the first optical axis 13a than the image-side lens elements 1303.

The light-blocking part 13043 has a light-blocking surface 13043a surrounding the first optical axis 13a. The light opening 13044 is defined by the light-blocking surface 13043a of the light-blocking part 13043.

The light-blocking surface 13043a of the light-blocking part 13043 continuously extends towards the object-side surface 13041 and the image-side surface 13042 without any crack. It can also be considered that the light-blocking surface 13043a extends from the object-side surface 13041 to the image-side surface 13042 in a continuous and no-crack manner. The light-blocking surface 13043a is arranged gradually away from the first optical axis 13a along a direction parallel to the first optical axis 13a and from the object side to the image side.

The light-blocking sheet 1304a further includes a plurality of specifically-shaped additives 13045. The specifically-shaped additives 13045 are uniformly distributed within the light-blocking sheet 1304a.

When a distance along the first optical axis 13a between the reflection surface 13010 and the image-side surface 13042 of the light-blocking sheet 1304a closest to the reflection surface 13010 is Db, and a distance along the first optical axis 13a between the reflection surface 13010 and the optical surface 13011 of the optical surfaces 13021a, 13021b and 13011 closest to the reflection surface 13010 is Do, the following conditions are satisfied: Db=4.12 mm; Do=3.68 mm; and Db/Do=1.12. Please be noted that both Db and Do are measured based on the positions where the reflection surface 13010 and the optical surface 13011 intersect the first optical axis 13a.

The light-blocking sheet 1304a of this embodiment can be replaced with different forms of light-blocking sheets, or a light-blocking layer can be alternatively disposed, provided that the imaging remains unaffected. Please continue to refer to the 14th and 15th embodiments.

### 14th Embodiment

Please refer to FIG. 34, which is a top view of a light-blocking sheet of an optical path folding camera module according to the 14th embodiment of the present disclosure.

In the following, a light-blocking sheet 1404a, which is provided in this embodiment and can be used to replace the light-blocking sheet 1304a in the 13th embodiment, would be illustrated. Please be noted that an optical path folding camera module 14 provided in this embodiment is similar to the optical path folding camera module 13 of the 13th embodiment, and therefore only differences between them, as well as necessary description, would be stated below.

The light-blocking part 14043 has a light-blocking surface 14043a surrounding the first optical axis 14a. The light opening 14044 is defined by the light-blocking surface 14043a.

Please refer to FIG. 34, the light-blocking part 14043 further has a plurality of curved structures 14043b in a direction perpendicular to the first optical axis 14a. The curved structures 14043b extend along a direction from the light-blocking surface 14043a to the first optical axis 14a. The curved structures 14043b are integrally formed with the light-blocking part 14043, but the present disclosure is not limited thereto.

When a curvature radius of the curved structures 14043b at a side thereof close to the object-side surface 14041 in a direction perpendicular to the first optical axis 14a is R, the following condition is satisfied: R=0.24 mm.

As shown in FIG. 34, the curved structures 14043b extending along a direction perpendicular to the first optical axis 14a are arranged in a loop along the whole contour of the inner edge of the light-blocking part 14043.

### 15th Embodiment

Please refer to FIG. 35 to FIG. 39, FIG. 35 is a perspective view of a light folding element and a light-blocking layer of an optical path folding camera module according to the 15th embodiment of the present disclosure, FIG. 36 is a cross-sectional view of the light folding element and the light-blocking layer in FIG. 35, FIG. 37 is a cross-sectional view of the light folding element and the light-blocking layer alone U-U line in FIG. 36, FIG. 38 is a top view of the light-blocking layer in FIG. 37, and FIG. 39 is a cross-sectional view of the light-blocking layer along V-V line in FIG. 38, with an enlarged view of WW region thereof.

In the following, a light-blocking layer 1504b, which is provided in this embodiment and can be used in the 13th embodiment, would be illustrated. Please be noted that an optical path folding camera module 15 provided in this embodiment is similar to the optical path folding camera module 13 of the 13th embodiment, and therefore only differences between them, as well as necessary description, would be stated below.

The light folding element 1501 has an optical surface 15011. The optical surface 15011 is disposed corresponding to the reflection surface 15010 along the first optical axis 15a, and the first optical axis 15a is disposed through the optical surface 15011. It can also be considered that the optical surface 15011 face away from the reflection surface 15010 along the first optical axis 15a.

The optical path folding camera module 15 further includes a light-blocking layer 1504b. The light-blocking layer 1504b is disposed on an object side of the reflection surface 15010 of the light folding element 1501 and is disposed between the optical surface 15011 and the reflection surface 15010.

The light-blocking layer 1504b includes an object-side surface 15041, an image-side surface 15042, a light-blocking part 15043 and a light opening 15044. The object-side surface 15041 faces towards the object side. The image-side surface 15042 is disposed opposite to the object-side surface 15041 and faces towards the reflection surface 15010. The light-blocking part 15043 is connected to the object-side surface 15041 and the image-side surface 15042.

The light-blocking part 15043 has a light-blocking surface 15043a surrounding the first optical axis 15a. The light opening 15044 is defined by the light-blocking surface 15043a of the light-blocking part 15043.

The light-blocking surface 15043a of the light-blocking part 15043 continuously extends towards the object-side surface 15041 and the image-side surface 15042 without any crack. It can also be considered that the light-blocking surface 15043a extends from the object-side surface 15041 to the image-side surface 15042 in a continuous and no-crack manner. The light-blocking surface 15043a is arranged gradually close to the first optical axis 15a along a direction parallel to the first optical axis 15a and from the object side to the image side.

Please refer to FIG. 37 and FIG. 38, the light-blocking part 15043 further has a plurality of curved structures 15043b in a direction perpendicular to the first optical axis 15a. The curved structures 15043b extend along a direction from the light-blocking surface 15043a to the first optical axis 15a. The curved structures 15043b are integrally formed with the light-blocking part 15043, but the present disclosure is not limited thereto.

When a distance along the first optical axis 15a between the reflection surface 15010 and the image-side surface 15042 of the light-blocking layer 1504b closest to the reflection surface 15010 is Db′, and a distance along the first optical axis 15a between the reflection surface 15010 and the optical surface 15011 is Do′, the following conditions are satisfied: Db′=2.91 mm; Do′=4.11 mm; and Db′/Do′=0.71. Please be noted that both Db′ and Do′ are measured based on the positions where the reflection surface 15010 and the optical surface 15011 intersect the first optical axis 15a. Please be noted that the light-blocking layer 1504b in this embodiment can be served as an additional component that can be additionally disposed in the 13th embodiment. Alternatively, the light-blocking layer 1304a of the 13th embodiment can be omitted, with the light-blocking layer 1504b in this embodiment only being disposed. However, the present disclosure is not limited thereto. Considering the two situations as mentioned above, the distances are denoted as Db′ and Do′ for preventing confusion with Db and Do in the 13th embodiment.

When a curvature radius of the curved structures 15043b at a side thereof close to the object-side surface 15041 in a direction perpendicular to the first optical axis 15a is R, the following condition is satisfied: R=0.16 mm.

As shown in FIG. 37 and FIG. 38, the curved structures 15043b extending along a direction perpendicular to the first optical axis 15a are arranged linearly substantially along the contour on the four sides of the inner edge of the light-blocking part 15043, wherein the light-blocking part 15043 further has a plurality of curved structures 15043c with different curvature radius at four corners of the contour thereof, and a curvature radius R″ of the curved structures 15043c is 1.46 mm.

### 16th Embodiment

Please refer to FIG. 40 to FIG. 45, where FIG. 40 is a perspective view of an optical path folding camera module according to the 16th embodiment of the present disclosure, FIG. 41 is a top view of the optical path folding camera module in FIG. 40, FIG. 42 is a cross-sectional view of the optical path folding camera module along X-X line in FIG. 41, FIG. 43 is a perspective view of the light folding element and the light-blocking layer of the optical path folding camera module in FIG. 42, FIG. 44 is a top view of the light-blocking layer in FIG. 43, and FIG. 45 is a cross-sectional view of the light folding element and the light-blocking layer in FIG. 43, with an enlarged view of YY region thereof.

An optical path folding camera module 16 provided in this embodiment has, in order from an object side to an image side, a first optical axis 16a and a second optical axis 16b.

The optical path folding camera module 16 includes a light folding element 1601 and a plurality of image-side lens elements 1603. The light folding element 1601 is a prism, but the present disclosure is not limited thereto. The image-side lens elements 1603 are two sets of lens groups, but the present disclosure is not limited thereto. Please be noted that part of the contours of the image-side lens elements 1603 is omitted.

The light folding element 1601 has a reflection surface 16010. The reflection surface 16010 deflects the first optical axis 16a to the second optical axis 16b. The second optical axis 16b is disposed through the image-side lens elements 1603 and extends to an image surface IMG.

The light folding element 1601 has an optical surface 16011. The optical surface 16011 is disposed corresponding to the reflection surface 16010 along the first optical axis 16a, and the first optical axis 16a is disposed through the optical surface 16011. It can also be considered that the optical surface 16011 faces away from the reflection surface 16010 along the first optical axis 16a.

The optical path folding camera module 16 further includes a light-blocking layer 1604b. The light-blocking layer 1604b is disposed on an object side of the reflection surface 16010 and is disposed between the optical surface 16011 and the reflection surface 16010. The light-blocking layer 1604b is disposed on the light folding element 1601. The light-blocking layer 1604b is partially attached on the optical surface 16011, and the light-blocking layer 1604b extends along a direction parallel to the first optical axis 16a and extends towards the first optical axis 16a.

The light-blocking layer 1604b includes an object-side surface 16041, an image-side surface 16042, a light-blocking part 16043 and a light opening 16044. The object-side surface 16041 faces towards the object side. The image-side surface 16042 is disposed opposite to the object-side surface 16041 and faces towards the reflection surface 16010. The light-blocking part 16043 is connected to the object-side surface 16041 and the image-side surface 16042. The light-blocking part 16043 is disposed facing towards the first optical axis 16a. The light-blocking part 16043 is located closer to the first optical axis 16a than the image-side lens elements 1603.

The light-blocking part 16043 has a light-blocking surface 16043a surrounding the first optical axis 16a. The light opening 16044 is defined by the light-blocking surface 16043a of the light-blocking part 16043.

The light-blocking surface 16043a of the light-blocking part 16043 continuously extends towards the object-side surface 16041 and the image-side surface 16042 without any crack. It can also be considered that the light-blocking surface 16043a extends from the object-side surface 16041 to the image-side surface 16042 in a continuous and no-crack manner. The light-blocking surface 16043a is arranged gradually close to the first optical axis 16a along a direction parallel to the first optical axis 16a and from the object side to the image side.

Please refer to FIG. 43 and FIG. 44, the light-blocking part 16043 further has a plurality of curved structures 16043b in a direction perpendicular to the first optical axis 16a. The curved structures 16043b extend along a direction from the light-blocking surface 16043a to the first optical axis 16a. The curved structures 16043b are integrally formed with the light-blocking part 16043, but the present disclosure is not limited thereto.

When a height of the light-blocking layer 1604b in a direction parallel to the first optical axis 16a is h1, and a height difference of the optical surface 16011 where the light-blocking layer 1604b is attached in a direction parallel to the first optical axis 16a is h2, the following conditions are satisfied: h1=0.519 mm; h2=0.847 mm; and h1/h2=0.613.

When a distance along the first optical axis 16a between the reflection surface 16010 and the image-side surface 16042 of the light-blocking layer 1604b closest to the reflection surface 16010 is Db, and a distance along the first optical axis 16a between the reflection surface 16010 and the optical surface 16011 closest to the reflection surface 16010 is Do, the following conditions are satisfied: Db=2.66 mm; Do=3.73 mm; and Db/Do=0.71. Please be noted that both Db and Do are measured based on the positions where the reflection surface 16010 and the optical surface 16011 intersect the first optical axis 16a.

When curvature radii of the curved structures 16043b at a side thereof close to the object-side surface 16041 in a direction perpendicular to the first optical axis 16a are R and R′, the following conditions are satisfied: R=0.2 mm; and R′=0.23 mm, as shown in FIG. 44.

As shown in FIG. 43 and FIG. 44, the curved structures 16043b extending along a direction perpendicular to the first optical axis 16a are arranged in a loop along the whole contour of the inner edge of the light-blocking part 16043.

### 17th Embodiment

Please refer to FIG. 46 to FIG. 47, where FIG. 46 is one perspective view of an electronic device according to the 17th embodiment of the present disclosure, and FIG. 47 is another perspective view of the electronic device in FIG. 46.

In this embodiment, an electronic device 17 is a smartphone including a plurality of camera modules, a flash module 171, a focus assist module 172, an image signal processor 173, a display module (user interface) 174 and an image software processor (not shown).

The camera modules include an ultra-wide-angle camera module 170a, a high pixel camera module 170b, a telephoto camera module 170c and a telephoto camera module 170. Moreover, the camera module 170 includes one of the optical path folding camera modules 1-16 of the present disclosure.

The image captured by the ultra-wide-angle camera module 170a enjoys a feature of multiple imaged objects. FIG. 48 is an image captured by the ultra-wide-angle camera module 170a. Moreover, the maximum field of view (FOV) of the camera module 170a corresponds to the viewing angle in FIG. 48.

The image captured by the high pixel camera module 170b enjoys a feature of high resolution and less distortion, and the high pixel camera module 170b can capture part of the image in FIG. 48. FIG. 49 is an image captured by the high pixel camera module 170b.

The image captured by the telephoto camera module 170c enjoys a feature of high optical magnification, and the telephoto camera module 170c can capture part of the image in FIG. 49. FIG. 50 is an image captured by the telephoto camera module 170c.

When a user captures images of an object, the light rays converge in the ultra-wide-angle camera module 170a, the high pixel camera module 170b, the telephoto camera module 170c or the telephoto camera module 170 to generate images, and the flash module 171 is activated for light supplement. The focus assist module 172 detects the object distance of the imaged object to achieve fast auto focusing. The image signal processor 173 is configured to optimize the captured image to improve image quality and provided zooming function. The light beam emitted from the focus assist module 172 can be either conventional infrared or laser. The display module 174 can include a touch screen, and the user is able to interact with the display module 174 to adjust the angle of view and switch between different camera modules, and the image software processor having multiple functions to capture images and complete image processing. Alternatively, the user may capture images via a physical button. The image processed by the image software processor can be displayed on the display module 174.

### 18th Embodiment

Please refer to FIG. 51, which is one perspective view of an electronic device according to the 18th embodiment of the present disclosure.

In this embodiment, an electronic device 18 is a smartphone including a camera module 180, a camera module 180a, a camera module 180b, a camera module 180c, a camera module 180d, a camera module 180e, a camera module 180f, a camera module 180g, a camera module 180h, a flash module 181, an image signal processor, a display module and an image software processor (not shown). The camera module 180, the camera module 180a, the camera module 180b, the camera module 180c, the camera module 180d, the camera module 180e, the camera module 180f, the camera module 180g and the camera module 180h are disposed on the same side of the electronic device 18, while the display module is disposed on the opposite side of the electronic device 18. Moreover, the camera module 180 includes one of the optical path folding camera modules 1-16 of the present disclosure.

The camera module 180 is a telephoto camera module, the camera module 180a is a telephoto camera module, the camera module 180b is a telephoto camera module, the camera module 180c is a telephoto camera module, the camera module 180d is a wide-angle camera module, the camera module 180e is a wide-angle camera module, the camera module 180f is an ultra-wide-angle camera module, the camera module 180g is an ultra-wide-angle camera module, and the camera module 180h is a ToF (time of flight) camera module. In this embodiment, the camera module 180, the camera module 180a, the camera module 180b, the camera module 180c, the camera module 180d, the camera module 180e, the camera module 180f and the camera module 180g have different fields of view, such that the electronic device 18 can have various magnification ratios so as to meet the requirement of optical zoom functionality. In addition, the camera module 180a and the camera module 180b each are a telephoto camera module having a light-folding element configuration. In addition, the camera module 180h can determine depth information of the imaged object. In this embodiment, the electronic device 18 includes a plurality of camera modules 180, 180a, 180b, 180c, 180d, 180e, 180f, 180g, and 180h, but the present disclosure is not limited to the number and arrangement of camera module. When a user captures images of an object, the light rays converge in the camera modules 180, 180a, 180b, 180c, 180d, 180e, 180f, 180g or 180h to generate an image(s), and the flash module 181 is activated for light supplement. Further, the subsequent processes are performed in a manner similar to the abovementioned embodiments, so the details in this regard will not be provided again.

### 19th Embodiment

Please refer to FIG. 52 to FIG. 54, where FIG. 52 is a perspective view of an electronic device according to the 19th embodiment of the present disclosure, FIG. 53 is a side view of the electronic device in FIG. 52, and FIG. 54 is a top view of the electronic device in FIG. 52.

In this embodiment, an electronic device 19 is an automobile. The electronic device 19 includes a plurality of automotive camera modules 190, and the camera modules 190, for example, each include one of the optical path folding camera modules 1-16 of the present disclosure. The camera modules 190 can be served as, for example, panoramic view car cameras, dashboard cameras and vehicle backup cameras.

As shown in FIG. 52, the camera modules 190 are disposed, for example, around the automobile to capture peripheral images of the automobile, which is favorable for recognizing road conditions outside the automobile so as to achieve an automatic driving assistant. In addition, the image software processor may stitch the peripheral images into a panorama image for the driver's checking every corner surrounding the automobile, thereby favorable for parking and driving.

As shown in FIG. 53, the camera modules 190 are disposed, for example, on the lower portions of the side mirrors. A maximum field of view of each of the camera modules 190 can range from 40 degrees to 90 degrees for capturing images on left and right sides within nearby lane regions.

As shown in FIG. 54, the camera modules 190 are disposed, for example, on the lower portions of the side mirrors and further at the inner sides of the front and rear windshields for providing external information to the driver, and also providing more viewing angles so as to reduce blind spots, thereby improving driving safety.

The smartphones or the automobile in the embodiments are only exemplary for showing the optical path folding camera modules 1-16 of the present disclosure installed in an electronic device 17, 18 or 19, and the present disclosure is not limited thereto. The optical path folding camera modules 1-16 can be optionally applied to optical systems with a movable focus. Furthermore, the optical path folding camera modules 1-16 feature good capability in aberration corrections and high image quality, and can be applied to 3D (three-dimensional) image capturing applications, in products such as digital cameras, mobile devices, digital tablets, smart televisions, network surveillance devices, multi-camera devices, image recognition systems, motion sensing input devices, wearable devices, other electronic imaging devices.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical path folding camera module having, in order from an object side to an image side, a first optical axis and a second optical axis, the optical path folding camera module comprising:
a light folding element having a reflection surface configured to deflect the first optical axis to the second optical axis;
an object-side lens element through which the first optical axis is disposed, wherein the object-side lens element has at least one optical surface being spherical or aspheric and being disposed corresponding to the reflection surface along the first optical axis;
an image-side lens element through which the second optical axis is disposed; and
a light-blocking sheet disposed between a surface of the at least one optical surface and the reflection surface, the light-blocking sheet comprising:
an object-side surface facing towards the object side;
an image-side surface disposed opposite to the object-side surface and facing towards the reflection surface;
a light-blocking part connected to the object-side surface and the image-side surface, wherein the light-blocking part is disposed facing towards the first optical axis, the light-blocking part is located closer to the first optical axis than the image-side lens element, and the light-blocking part has a light-blocking surface surrounding the first optical axis; and
a light opening defined by the light-blocking surface of the light-blocking part;
wherein the light-blocking surface of the light-blocking part continuously extends towards the object-side surface and the image-side surface without any crack.

2. The optical path folding camera module according to claim 1, wherein a distance along the first optical axis between the reflection surface and a surface of the light-blocking sheet closest to the reflection surface is Db, a distance along the first optical axis between the reflection surface and a surface of the at least one optical surface closest to the reflection surface is Do, and the following condition is satisfied:
0.3<Db/Do<2.

3. The optical path folding camera module according to claim 2, wherein the distance along the first optical axis between the reflection surface and the surface of the light-blocking sheet closest to the reflection surface is Db, the distance along the first optical axis between the reflection surface and the surface of the at least one optical surface closest to the reflection surface is Do, and the following condition is satisfied:
0.5<Db/Do<1.3.

4. The optical path folding camera module according to claim 1, wherein the light-blocking surface of the light-blocking part is arranged, from the object-side surface to the image-side surface, gradually close to the first optical axis or gradually away from the first optical axis.

5. The optical path folding camera module according to claim 2, wherein the light-blocking part further has a plurality of curved structures in a direction perpendicular to the first optical axis, the plurality of curved structures extend towards the first optical axis from the light-blocking surface, and the plurality of curved structures are arranged along at least one contour of the light-blocking part.

6. The optical path folding camera module according to claim 5, wherein a curvature radius of the plurality of curved structures at a side thereof close to the object-side surface in a direction perpendicular to the first optical axis is R, and the following condition is satisfied:
0.05 mm≤R<1.7 mm.

7. The optical path folding camera module according to claim 6, wherein the curvature radius of the plurality of curved structures at the side thereof close to the object-side surface in the direction perpendicular to the first optical axis is R, and the following condition is satisfied:
0.08 mm≤R<1.5 mm.

8. The optical path folding camera module according to claim 1, wherein the light-blocking sheet further comprises a plurality of specifically-shaped additives uniformly distributed within the light-blocking sheet.

9. The optical path folding camera module according to claim 1, further comprising a driving device, wherein the driving device provides the light folding element with a rotation axis and a degree of freedom rotating about the rotation axis.

10. The optical path folding camera module according to claim 5, wherein the plurality of curved structures are arranged along a straight line in a direction parallel to the second optical axis.

11. An electronic device comprising:
the optical path folding camera module of claim 1.

12. An optical path folding camera module having, in order from an object side to an image side, a first optical axis and a second optical axis, the optical path folding camera module comprising:
a light folding element having:
a reflection surface configured to deflect the first optical axis to the second optical axis; and
at least one optical surface through which the first optical axis is disposed, wherein the at least one optical surface is spherical or aspheric;
an image-side lens element through which the second optical axis is disposed; and
a light-blocking layer disposed on an object side of the reflection surface, the light-blocking layer comprising:
an object-side surface facing towards the object side;
an image-side surface disposed opposite to the object-side surface and facing towards the reflection surface;
a light-blocking part connected to the object-side surface and the image-side surface, wherein the light-blocking part is disposed facing towards the first optical axis, the light-blocking part is located closer to the first optical axis than the image-side lens element, and the light-blocking part has a light-blocking surface surrounding the first optical axis; and
a light opening defined by the light-blocking surface of the light-blocking part;
wherein the light-blocking layer is attached on the at least one optical surface, and the light-blocking layer extends along a direction parallel to the first optical axis and extends towards the first optical axis;
wherein a height of the light-blocking layer in a direction parallel to the first optical axis is h1, a height difference of a surface of the at least one optical surface where the light-blocking layer is attached in a direction parallel to the first optical axis is h2, a distance along the first optical axis between the reflection surface and a surface of the light-blocking layer closest to the reflection surface is Db, a distance along the first optical axis between the reflection surface and a surface of the at least one optical surface closest to the reflection surface is Do, and the following conditions are satisfied:
0<h1/h2<1.2; and 0.3<Db/Do<2.

13. The optical path folding camera module according to claim 12, wherein the distance along the first optical axis between the reflection surface and the surface of the light-blocking layer closest to the reflection surface is Db, the distance along the first optical axis between the reflection surface and the surface of the at least one optical surface closest to the reflection surface is Do, and the following condition is satisfied:
0.5<Db/Do<1.3.

14. The optical path folding camera module according to claim 12, further comprising an object-side lens element through which the first optical axis is disposed.

15. The optical path folding camera module according to claim 12, wherein the light-blocking surface of the light-blocking part is arranged, from the object-side surface to the image-side surface, gradually close to the first optical axis or gradually away from the first optical axis.

16. The optical path folding camera module according to claim 12, wherein the light-blocking part further has a plurality of curved structures in a direction perpendicular to the first optical axis, the plurality of curved structures extend towards the first optical axis from the light-blocking surface, and the plurality of curved structures are arranged along at least one contour of the light-blocking part.

17. The optical path folding camera module according to claim 16, wherein a curvature radius of the plurality of curved structures at a side thereof close to the object-side surface in a direction perpendicular to the first optical axis is R, and the following condition is satisfied:
0.05 mm≤R<1.7 mm.

18. The optical path folding camera module according to claim 17, wherein the curvature radius of the plurality of curved structures at the side thereof close to the object-side surface in the direction perpendicular to the first optical axis is R, and the following condition is satisfied:
0.08 mm≤R<1.5 mm.

19. The optical path folding camera module according to claim 12, further comprising a driving device, wherein the driving device provides the light folding element with a rotation axis and a degree of freedom rotating about the rotation axis.

20. The optical path folding camera module according to claim 16, wherein the plurality of curved structures are arranged along a straight line in a direction parallel to the second optical axis.

21. An optical path folding camera module having, in order from an object side to an image side, a first optical axis and a second optical axis, the optical path folding camera module comprising:
a light folding element having a reflection surface configured to deflect the first optical axis to the second optical axis;
an object-side lens element through which the first optical axis is disposed, wherein the object-side lens element has at least one optical surface being spherical or aspheric;
an image-side lens element through which the second optical axis is disposed; and
a light-blocking layer disposed on the light folding element, the light-blocking layer comprising:
an object-side surface facing towards the object side;
an image-side surface disposed opposite to the object-side surface and facing towards the reflection surface;
a light-blocking part connected to the object-side surface and the image-side surface, wherein the light-blocking part is disposed facing towards the first optical axis, the light-blocking part is located closer to the first optical axis than the image-side lens element, and the light-blocking part has a light-blocking surface surrounding the first optical axis; and
a light opening defined by the light-blocking surface of the light-blocking part;
wherein the light-blocking part further has a plurality of curved structures in a direction perpendicular to the first optical axis, the plurality of curved structures extend towards the first optical axis from the light-blocking surface, and the plurality of curved structures are arranged along a whole contour of at least one side of the light-blocking part.

22. The optical path folding camera module according to claim 21, wherein a distance along the first optical axis between the reflection surface and a surface of the light-blocking layer closest to the reflection surface is Db, a distance along the first optical axis between the reflection surface and a surface of the at least one optical surface closest to the reflection surface is Do, and the following condition is satisfied:
0.3<Db/Do<2.

23. The optical path folding camera module according to claim 22, wherein the distance along the first optical axis between the reflection surface and the surface of the light-blocking layer closest to the reflection surface is Db, the distance along the first optical axis between the reflection surface and the surface of the at least one optical surface closest to the reflection surface is Do, and the following condition is satisfied:
0.5<Db/Do<1.3.

24. The optical path folding camera module according to claim 21, wherein the light-blocking surface of the light-blocking part is arranged, from the object-side surface to the image-side surface, gradually close to the first optical axis or gradually away from the first optical axis.

25. The optical path folding camera module according to claim 21, wherein a curvature radius of the plurality of curved structures at a side thereof close to the object-side surface in a direction perpendicular to the first optical axis is R, and the following condition is satisfied:
0.05 mm≤R<1.7 mm.

26. The optical path folding camera module according to claim 25, wherein the curvature radius of the plurality of curved structures at the side thereof close to the object-side surface in the direction perpendicular to the first optical axis is R, and the following condition is satisfied:
0.08 mm≤R<1.5 mm.

27. The optical path folding camera module according to claim 21, wherein the light-blocking surface of the light-blocking part continuously extends towards the object-side surface and the image-side surface without any crack.

28. The optical path folding camera module according to claim 27, wherein the light-blocking layer further comprises a plurality of specifically-shaped additives uniformly distributed within the light-blocking layer.

29. The optical path folding camera module according to claim 21, wherein the light-blocking layer is attached on the at least one optical surface, and the light-blocking layer extends along a direction parallel to the first optical axis and extends towards the first optical axis.

30. The optical path folding camera module according to claim 29, wherein a height of the light-blocking layer in a direction parallel to the first optical axis is h1, a height difference of a surface of the at least one optical surface where the light-blocking layer is attached in a direction parallel to the first optical axis is h2, the following condition is satisfied:
0<h1/h2<1.2.

31. The optical path folding camera module according to claim 21, further comprising a driving device, wherein the driving device provides the light folding element with a rotation axis and a degree of freedom rotating about the rotation axis.

32. The optical path folding camera module according to claim 21, wherein the plurality of curved structures are arranged along a straight line in a direction parallel to the second optical axis.

33. An optical path folding camera module having, in order from an object side to an image side, a first optical axis and a second optical axis, the optical path folding camera module comprising:
a light folding element having a reflection surface configured to deflect the first optical axis to the second optical axis;
an object-side lens element through which the first optical axis is disposed, wherein the object-side lens element has at least one optical surface being spherical or aspheric and being disposed corresponding to the reflection surface along the first optical axis;
an image-side lens element through which the second optical axis is disposed; and
a light-blocking sheet disposed between a surface of the at least one optical surface and the reflection surface, the light-blocking sheet comprising:
an object-side surface facing towards the object side;
an image-side surface disposed opposite to the object-side surface and facing towards the reflection surface;
a light-blocking part connected to the object-side surface and the image-side surface, wherein the light-blocking part is disposed facing towards the first optical axis, the light-blocking part is located closer to the first optical axis than the image-side lens element, and the light-blocking part has a light-blocking surface surrounding the first optical axis; and
a light opening defined by the light-blocking surface of the light-blocking part;
wherein the light-blocking part further has a plurality of curved structures in a direction perpendicular to the first optical axis, the plurality of curved structures extend towards the first optical axis from the light-blocking surface, and the plurality of curved structures are arranged along at least one contour of the light-blocking part;
wherein the light-blocking surface of the light-blocking part is arranged, from the object-side surface to the image-side surface, gradually close to the first optical axis or gradually away from the first optical axis.

34. The optical path folding camera module according to claim 33, wherein a distance along the first optical axis between the reflection surface and a surface of the light-blocking sheet closest to the reflection surface is Db, a distance along the first optical axis between the reflection surface and a surface of the at least one optical surface closest to the reflection surface is Do, and the following condition is satisfied:
0.3<Db/Do<2.

35. The optical path folding camera module according to claim 34, wherein the distance along the first optical axis between the reflection surface and the surface of the light-blocking sheet closest to the reflection surface is Db, the distance along the first optical axis between the reflection surface and the surface of the at least one optical surface closest to the reflection surface is Do, and the following condition is satisfied:
0.5<Db/Do<1.3.

36. The optical path folding camera module according to claim 33, wherein a curvature radius of the plurality of curved structures at a side thereof close to the object-side surface in a direction perpendicular to the first optical axis is R, and the following condition is satisfied:
0.05 mm≤R<1.7 mm.

37. The optical path folding camera module according to claim 36, wherein the curvature radius of the plurality of curved structures at the side thereof close to the object-side surface in the direction perpendicular to the first optical axis is R, and the following condition is satisfied:
0.08 mm≤R<1.5 mm.

38. The optical path folding camera module according to claim 33, wherein the light-blocking surface of the light-blocking part continuously extends towards the object-side surface and the image-side surface without any crack.

39. The optical path folding camera module according to claim 38, wherein the light-blocking sheet further comprises a plurality of specifically-shaped additives uniformly distributed within the light-blocking sheet.

40. The optical path folding camera module according to claim 33, further comprising a driving device, wherein the driving device provides the light folding element with a rotation axis and a degree of freedom rotating about the rotation axis.

41. The optical path folding camera module according to claim 33, wherein the plurality of curved structures are arranged along a straight line in a direction parallel to the second optical axis.
